(19) United States
(12) Patent Application Publication
(10) Pub. No.: US 2006/0126438 A1
(43) Pub. Date: Jun. 15, 2006

(54) Radio-controlled clock/watch

(76) Inventors: Shizue Itou, Tokyo (JP); Minoru Kobayashi, Tokyo (JP); Takashi Ihara, Tokyo (JP); Shigeyuki Takahashi, Tokyo (JP)

Correspondence Address: THE WEBB LAW FIRM, P.C., 700 KOPPERS BUILDING, 436 SEVENTH AVENUE, PITTSBURGH, PA, 15219, US

(21) Appl. No.: 10/519,237

(22) PCT Filed: Dec. 26, 2003
(86) PCT No.: PCT/JP03/16970

§ 371 Date: Dec. 23, 2004

(30) Foreign Application Priority Data
Dec. 27, 2002 (JP) 2002-379043
Feb. 19, 2003 (JP) 2003-041352
Feb. 21, 2003 (JP) 2003-044185
Mar. 27, 2003 (JP) 2003-086837

(51) Int. Cl. G04C 11/02

(52) U.S. Cl. 368/47

(57) ABSTRACT

There are provided an antenna for receiving a radio wave including time information, a watch device for causing a display portion to display time information such as a present time by the radio wave received by the antenna, a watch case for accommodating the antenna and the watch device, and at least one non-magnetic member fixed to an internal surface of the watch case and having an electric resistivity set to be 7.0 μΩ-Cm or less.

### TECHNICAL FIELD

The present invention relates to a radio controlled watch for receiving a predetermined radio wave including time information and displaying a time. More particularly, the present invention relates to a structure of a case of a radio controlled watch to enhance a radio wave receiving performance and to improve a magnetism resistant performance to an external magnetism in the case in which an ordinary metal watch case is used.

### BACKGROUND ART

There has already been known an electronic watch for receiving a standard radio wave, that is, a radio controlled watch capable of receiving a standard radio wave (a carrier wave) including time information and fetching the time information from the radio wave, thereby obtaining an accurate time. The radio wave including the time information has a frequency varied for each country. In Japan, for example, standard radio waves of 40 kHz and 60 kHz are transmitted under control of the Ministry of Internal Affairs and Communications (MIC) and the Postal-services agency.

FIG. 26 is a block diagram schematically showing the function of such a radio controlled watch. The radio controlled watch is constituted by an antenna 1, a radio controlled watch receiver 2, a CPU 3, a display driving portion 4, an input device 5 and the like. In addition, there is included each hand for hour, minute and second or a display portion constituted by a liquid crystal or the like which is not shown.

In the radio controlled watch, a radio wave including time information is first received by the antenna 1. The radio controlled watch receiver 2 amplifies and detects the radio wave received by the antenna 1, and fetches and outputs the time information from the radio wave. The CPU 3 outputs present time data based on the time information output from the radio controlled watch receiver 2. The display driving portion 4 causes a display portion to display a present time based on the present time data output from the CPU 3. The input device 5 is used when inputting operation information such as a reset to the CPU 3, for example.

Time information (time code) included in a radio wave is a pulse signal having a cycle of 60 seconds and is varied depending on a country. In Japan, there is one pulse having a width of 200, 500 or 800 msec every second. By the combination of these pulses, the time information is obtained in 60 seconds.

The CPU 3 reads the width of a pulse every second from the received pulse signal, thereby acquiring time information (a present time). The CPU corrects a displayed time in the display portion through the display driving portion 4 based on the acquired time information. Consequently, the radio controlled watch can always display an accurate time by correcting the displayed time every predetermined interval based on the received time information.

A watch for accommodating an antenna, a radio controlled watch receiver, a CPU, a display driving portion and a display portion in a case to be an antenna housing has already been provided as the radio controlled watch. A non-conductive material such as a synthetic resin or ceramic has mainly been used for the material of the case in order to receive a radio wave through the antenna.

More specifically, if the antenna is accommodated in a case formed by a conductive material such as a metal, a magnetic flux generated in the vicinity of the antenna is absorbed into the conductive material so that a resonant phenomenon is prevented. For this reason, the receiving function of the antenna is remarkably deteriorated so that the antenna cannot receive a standard radio wave.

In order to avoid the receiving failure of the antenna,. however, if a case formed of a synthetic resin is used, the damage resistance or chemical resistance of the case is deteriorated. In addition, a sense of high grade and a fine appearance which are required for a watch to be accessories are also deteriorated. For this reason, a radio controlled watch using a metal for a case has been proposed.

FIG. 27 is a sectional view showing an example of the structure of a radio controlled watch using a metal for a part of a case.

A watch case 10 is schematically constituted by a watch case body 11, a back cover 12 and a wind shield 13. A movement 14 is provided in the body to which a band (not shown) is coupled through well-known means. Similarly, a dial Plate 15 and a hand 16 which serve as time display portions are provided above the movement 14 through well-known means.

A bar antenna 17 to be a magnetic long wave antenna is provided to be positioned below the movement 14 and above the back cover 12. The bar antenna 17 includes a magnetic core member 18 formed by a ferrite material and a coil 20 wound around the magnetic core member 18, and is fixed to the upper surface of a holding member formed by a synthetic resin.

The movement 14 includes the radio controlled watch receiver 2, the CPU 3 and the display driving portion 4 as shown in FIG. 26 described above, and is electrically conducted to the bar antenna through a conductor 21.

Accordingly, based on a standard radio wave received by the bar antenna 17, the CPU of the movement 14 operates a gear mechanism which is not shown in the display driving portion, thereby driving the gear mechanism in order to always correct the position of the hand 16 in the display portion. A vertical direction indicates upper and lower parts in FIG. 27.

The watch case body 11 is formed by a conductive material which is not hollow, that is, a solid metal, for example, solid stainless steel. The wind shield 13 formed by a glass to be a non-conductive material is fixed to the uppermost part of the watch case body 11 through well-known means such as adhesion. The dial plate 15 is formed of a synthetic resin, ceramic or the like which is a non-conductive material. The back cover 12 is constituted by a ring-shaped edge frame 22 formed of stainless steel which is fixed to the watch case body 11, and a glass 23 fixed into the edge frame. In the watch, thus, a non-conductive material can be viewed on the upper and lower surfaces of the case and the side surface portion of the case is constituted by a metal. Therefore, there is an advantage that a sense of high grade and a fine appearance of accessories can be prevented from being deteriorated (see Japanese Laid-Open Patent Publication No. 2001-33571).

However, the watch shown in FIG. 27 has no great problem in a radio wave receiving performance for portable use. The glass 23 is fixed to the edge frame 22 of the back cover 12. For this reason, there is a problem in that the glass 23 is broken if a shock is applied, for example, the watch is dropped.

Moreover, the back cover 12 is provided in close contact with an arm. In use for a long period of time, therefore, there is a possibility that the glass 23 might slip off from the edge frame 22 due to a sweat or the like. Furthermore there is also possibility the sweat, water, dust or the like might enter the movement (the antenna 1, the radio controlled watch receiver 2, the CPU 3, the display driving portion 4 or the like) in the watch, resulting in a remarkable deterioration in the function of the watch.

In addition, the glass 23 is provided in the back cover 12. For this reason, there is a problem in that the number of components is increased and an assembly man-day is also increased, resulting in an increase in a cost. Furthermore, a non-metal member is used for an exterior member. Therefore, a sense of weight and thickness for the watch is lacked and a sense of high grade and the quality of an appearance also have drawbacks.

Furthermore, the watch shown in FIG. 27 employs a metal for the body of a case. For this reason, it is impossible to eliminate a disadvantage that an antenna is provided close to a metal member. As compared with the case in which the whole case is constituted by a non-conductive material, accordingly, the receiving performance of the bar antenna of the watch is reduced by approximately 40%. In an environment in which a standard radio wave is received with difficulty as in a place having a great distance from a transmitting station for the standard radio wave, the radio controlled watch cannot receive the standard radio wave in many cases.

On the other hand, in a watch for driving a hand through a motor, the driving operation of the hand is generally influenced by an external magnetism so that precision in the watch is deteriorated in some cases. For this reason, an antimagnetic plate for blocking the external magnetism is provided in the watch case, thereby holding the precision in the watch.

FIG. 28 is a sectional view showing the structure of a watch in which the antimagnetic plate for preventing the influence of the external magnetism as described above is provided between a middle frame for holding a movement and a back cover.

In the structure, a middle frame 6 for fixing a movement 4 is provided in a case 2 and an upward U-shaped magnetism resistant plate 10 is attached to a back cover 8 side of the middle frame 6, thereby surrounding the movement 4 (see Japanese Utility Model Registration No. 2505967).

The antimagnetic plate 10 is fixed to a module with a screw or chamfer as described above or is interposed between a core 8a of the back cover 8 and the middle frame 6 and is thus fixed, or is bonded and fixed to the internal surface of the back cover 8 with an adhesive, and is fixed with a fixing structure corresponding to a space in a watch case and the structure of the module or the like.

Also in a radio controlled watch having the same structure as the structure of a general watch for hand driving, similarly, a counter measure against a magnetism resistance is required for holding precision in a watch. However, the radio controlled watch serves to receive a standard radio wave (a carrier wave) including time information and to fetch the time information from the radio wave, thereby obtaining and displaying an accurate time. When the movement is surrounded by the magnetic resistant plate in order to block the external magnetism, there is a possibility that the receiving performance might be deteriorated. For this reason, in the radio controlled watch, the magnetic resistant plate could not be used.

In consideration of the problems of the conventional art, it is an object of the present invention to provide a radio controlled watch case capable of receiving a radio wave including predetermined information such as time information without a hindrance for carrying even if an ordinary metal watch case is used, enhancing stable waterproof quality and the quality of an appearance having a sense of high grade, and increasing the same design variation as that of a general watch.

Moreover, it is an object of the present invention to provide a radio controlled watch capable of receiving a radio wave including predetermined information such as time information even if a watch case having an antimagnetic plate provided in a case is used, and of holding predetermined precision in a time also in a certain environment having an external magnetism.

### DISCLOSURE OF THE INVENTION

The present invention has been made in order to solve the problems and to attain the objects in the conventional art described above, and a radio controlled watch according to the present invention comprises:

an antenna for receiving a radio wave including time information;

a watch device for causing a display portion to display time information such as a present time by the radio wave received by the antenna;

a watch case for accommodating the antenna and the watch device; and

at least one non-magnetic member fixed to an internal surface of the watch case and having an electric resistivity set to be 7.0 μΩ-Cm or less.

Moreover, the radio controlled watch according to the present invention is characterized in that the watch case is formed by at least one material selected from titanium, a titanium alloy, stainless steel, tungsten carbide and tantalum carbide, and

the non-magnetic member is fixed to an internal surface of the watch case.

Furthermore, the radio controlled watch according to the present invention is characterized in that the watch case includes a watch case body,

the watch case body being formed by at least one material selected from titanium, a titanium alloy, stainless steel, tungsten carbide and tantalum carbide, and

the non-magnetic member is fixed to an internal surface of the watch case body.

In addition, the radio controlled watch according to the present invention is characterized in that the watch case includes a watch case body and a back cover attached and fixed to the watch case body,

the back cover being formed by at least one material selected from titanium, a titanium alloy, stainless steel, tungsten carbide and tantalum carbide, and

the non-magnetic member is fixed to an internal surface of the back cover.

Thus, the non-magnetic member having the electric resistivity of 7.0 μΩ-Cm or less is provided in the watch case accommodating the antenna and the watch device. Consequently, it is possible to reduce the disturbance of a resonant phenomenon in the vicinity of the antenna which is caused by a metal material. Therefore, it is possible to obtain a sufficient receiving sensitivity also in a metal watch case.

By using the non-magnetic member having the electric resistivity of 7.0 μΩ-Cm or less as a non-magnetic member to be fixed to the watch case, for example, the watch case body and the internal surface of the back cover in the radio controlled watch, consequently, it is possible to use a metal having the excellent quality of an appearance such as titanium, a titanium alloy, stainless steel or tantalum carbide which has a low receiving sensitivity, a low frequency selectivity and a high electric resistivity as the watch case, for example, the watch case body and the back cover without sacrificing the receiving sensitivity. Thus, it is possible to enhance functions in respect of the mechanism and appearance of the watch case.

Moreover, the radio controlled watch according to the present invention is characterized in that the non-magnetic member is formed by at least one material selected from gold, silver, copper, brass, aluminum, magnesium, zinc and their alloy.

Furthermore, the radio controlled watch according to the present invention is characterized in that the non-magnetic member is formed by bonding at least two materials selected from gold, silver, copper, brass, aluminum, magnesium and their alloy.

The gold, the silver, the copper, the brass, the aluminum, the magnesium or their alloy is a metal having an electric resistivity of 7.0 μΩ-Cm or less. By using such a metal as the non-magnetic member to be fixed to the watch case body of the watch case or the internal surface of the back cover, it is possible to increase a receiving sensitivity and a frequency selectivity and to reduce the disturbance of a resonant phenomenon in the vicinity of the antenna which is caused by a metal material. Thus, it is possible to obtain a sufficient receiving sensitivity also in a metal watch case.

In addition, the radio controlled watch according to the present invention is characterized in that a resin member is provided in close contact with an internal surface of the non-magnetic member.

By such a structure, it is possible to prevent the antenna from being coming in contact with the non-magnetic member to cause the damage of the antenna, resulting in a deterioration in a receiving state.

Moreover, the radio controlled watch according to the present invention is characterized in that the antenna is constituted by a magnetic core member and a coil wound around the magnetic core member in plural turns, and

the non-magnetic member is provided in a position in which the antenna is projected onto the internal surface of the watch case in parallel along at least one plane including an axis of the magnetic core member.

Furthermore, the radio controlled watch according to the present invention is characterized in that the antenna is constituted by the magnetic core member and the coil wound around the magnetic core member in plural turns, and

the non-magnetic member is provided in a position of the watch case body in which the antenna is projected onto the internal surface of the watch case in parallel along at least one plane including the axis of the magnetic core member.

In addition, the radio controlled watch according to the present invention is characterized in that the antenna is constituted by the magnetic core member and the coil wound around the magnetic core member in plural turns, and

the non-magnetic member is provided in a position of the back cover in which the antenna is projected onto the internal surface of the watch case in parallel along at least one plane including the axis of the magnetic core member.

Moreover, the radio controlled watch according to the present invention is characterized in that the antenna is constituted by a magnetic core member and a coil wound around the magnetic core member in plural turns, and

the non-magnetic member is provided in a position of the internal surface of the watch case which is opposed to at least one end in an axial direction of the antenna.

The non-magnetic member is provided in such a position. Consequently, the non-magnetic member is positioned in the vicinity of the antenna so that it is possible to reduce the disturbance of a resonant phenomenon in the vicinity of the antenna which is caused by a metal material. Therefore, it is possible to obtain a sufficient receiving sensitivity also in a metal watch case.

Furthermore, the radio controlled watch according to the present invention is characterized in that the watch case is constituted by a clad material obtained by bonding the non-magnetic member in pressure contact with at least one material selected from titanium, a titanium alloy and stainless steel.

In addition, the radio controlled watch according to the present invention is characterized in that the watch case includes a watch case body,

the watch case body being constituted by a clad material obtained by bonding the non-magnetic member in pressure contact with at least one material selected from titanium, a titanium alloy and stainless steel.

Moreover, the radio controlled watch according to the present invention is characterized in that the watch case includes a watch case body and a back cover attached and fixed to the watch case body,

the back cover being constituted by a clad material obtained by bonding the non-magnetic member in pressure contact with at least one material selected from titanium, a titanium alloy and stainless steel.

By such a structure, it is also possible to integrally bond and fix the non-magnetic member to the watch case body and the back cover as the watch case in the stage of a material, for example, and to then adjust a shape. Consequently, it is possible to correspond to the complicated shape of the watch case, and furthermore, to simplify a manufacturing process, thereby reducing a cost.

Furthermore, the radio controlled watch according to the present invention is characterized in that the non-magnetic member is fixed to the watch case by at least one means such as press fitting, caulking, welding, soldering and an adhesive.

In addition, the radio controlled watch according to the present invention is characterized in that the watch case includes a watch case body, and

the non-magnetic member is fixed to the watch case body by at least one means such as press fitting, caulking, welding, soldering and an adhesive.

Moreover, the radio controlled watch according to the present invention is characterized in that the watch case includes a watch case body and a back cover attached and fixed to the watch case body, and

the non-magnetic member is fixed to the back cover by at least one means such as press fitting, caulking, welding, soldering and an adhesive.

By such a structure, it is possible to easily fix the non-magnetic member to the internal surface of the watch case, for example, the internal surfaces of the watch case body and the back cover.

Furthermore, the radio controlled watch according to the present invention is characterized in that the non-magnetic member fixed to the watch case is formed by means such as a wet plating method or a metal spraying method.

In addition, the radio controlled watch according to the present invention is characterized in that the watch case includes a watch case body, and

the non-magnetic member fixed to the watch case body is formed by means such as a wet plating method or a metal spraying method.

Moreover, the radio controlled watch according to the present invention is characterized in that the watch case includes a watch case body and a back cover attached and fixed to the watch case body, and

the non-magnetic member fixed to the back cover is for med by means such as a wet plating method or a metal spraying method.

By such a structure, it is possible to easily fix the non-magnetic member to the internal surface of the watch case, for example, the internal surfaces of the watch case body and the back cover by a wet plating method or a metal spraying method. Consequently, it is possible to correspond to the complicated shape of the watch case, and furthermore, to simplify a manufacturing process, thereby reducing a cost.

Furthermore, the radio controlled watch according to the present invention is characterized in that the non-magnetic member has a thickness of 50 am to 2000 μm.

If the non-magnetic member has a thickness within such a ranges the antenna has a high gain, a receiving sensitivity is high and a frequency selectivity is excellent. In addition, the thickness is optimum in consideration of a distance between the watch case body or the back cover and the movement or the antenna or an easiness to handle the non-magnetic member in manufacture and assembly.

In addition, a radio controlled watch according to the present invention comprises:

an antenna for receiving a radio wave including time information;

a watch device for causing a display portion to display time information such as a present time by the radio wave received by the antenna; and

a watch case for accommodating the antenna and the watch device, wherein the watch case has at least a part constituted by a non-magnetic member having an electric resistivity of 7.0 μΩ-Cm or less, and

a surface of the watch case is subjected to surface finishing.

Moreover, the radio controlled watch according to the present invention is characterized in that the watch case includes a watch case body, a back cover and a bezel,

at least one of the watch case body, the back cover and the bezel is constituted by a non-magnetic member, and

the watch case other than the watch case constituted by the non-magnetic member is constituted by at least one material selected from titanium, a titanium alloy, stainless steel, tungsten carbide, tantalum carbide and a resin.

By such a structure, a part of the watch case, for example, a part of the watch case body, the back cover, the bezel or the like, or at least one of them is formed by the non-magnetic member having the electric resistivity of 7.0 μΩ-Cm or less. Therefore, the disturbance of a resonant phenomenon in the vicinity of the antenna which is caused by the metal material can be reduced by the non-magnetic material. Consequently, it is possible to obtain a sufficient receiving sensitivity also in the metal watch case.

By using the non-magnetic member having the electric resistivity of 7.0 μΩ-Cm or less for a part of the watch case, for example, a part of the watch case body, the back cover, the bezel or the like, or at least one of them in the radio controlled watch, consequently, it is possible to use a metal having the excellent quality of an appearance such as titanium, a titanium alloy, stainless steel or tantalum carbide which has a low receiving sensitivity, a low frequency selectivity and a high electric resistivity as a watch case portion other than the watch case portion formed by the non-magnetic member without sacrificing the receiving sensitivity. Thus, it is possible to enhance functions in respect of the mechanism and appearance of the watch case.

In addition, the surface finishing is carried out over the surface of the watch case portion formed by the non-magnetic member. Therefore, it is possible to design and manufacture a watch case having a corrosion resistance, a heat resistance, a mechanical strength and the like and having a color tone such as a metal color having a sense of high grade and the high quality of an appearance, for example, a watch case body, a back cover, a bezel and the like in the same manner as in a general watch which is not the radio controlled watch. Thus, the design variation of the case in the radio controlled watch can be increased equivalently to the general watch.

Furthermore, the radio controlled watch according to the present invention is characterized in that the non-magnetic member is constituted by at least one material selected from gold, silver, copper, brass, aluminum, magnesium, zinc and their alloy.

In addition, the radio controlled watch according to the present invention is characterized in that the non-magnetic member is formed by bonding at least two materials selected from gold, silver, copper, brass, aluminum, magnesium and their alloy.

The gold, the silver, the copper, the brass, the aluminum, the magnesium or their alloy is a metal having an electric resistivity of 7.0 μΩ-Cm or less. By using such a metal as the non-magnetic member of a part of the watch case, for example, a part of the watch case body, the back cover, the bezel or the like, or at least one of them, it is possible to increase both a receiving sensitivity and a frequency selectivity and to reduce the disturbance of a resonant phenomenon in the vicinity of the antenna which is caused by a metal material. Thus, it is possible to obtain a sufficient receiving sensitivity also in a metal watch case.

Moreover, the radio controlled watch according to the present invention is characterized in that the antenna is constituted by a magnetic core member and a coil wound around the magnetic core member in plural turns, and

a member of the watch case onto which the antenna is projected in parallel along at least one plane including an axis of the magnetic core member or a portion onto which the projected member of the watch case is projected is constituted by the non-magnetic member.

Furthermore, the radio controlled watch according to the present invention is characterized in that the antenna is constituted by a magnetic core member and a coil wound around the magnetic core member in plural turns, and

a member of the watch case opposed to at least one end in an axial direction of the antenna or a portion opposed to the member of the watch case opposed to the end in the axial direction is constituted by the non-magnetic member.

The non-magnetic member is provided in such-a position. Consequently, the non-magnetic member is positioned in the vicinity of the antenna so that it is possible to reduce the disturbance of a resonant phenomenon in the vicinity of the antenna which is caused by a metal material. Therefore, it is possible to obtain a sufficient receiving sensitivity also in a metal watch case.

In addition, the radio controlled watch according to the present invention is characterized in that the surface finishing is constituted by at least one surface finishing process selected from a mirror finished surface, a mat finished surface, a hairline patterning, a pattern and a letter.

Thus, the surface finishing is constituted by the mirror finished surface, the mat finished surface, the hairline-patterning, the pattern and the letter. Consequently, it is possible to design and manufacture a watch case having a sense of high grade and the high quality of an appearance, for example, a watch case body, a back cover, a bezel and the like in the same manner as in a general watch which is not the radio controlled watch. Thus, the design variation of the case in the radio controlled watch can be increased equivalently to the general watch.

Moreover, the radio controlled watch according to the present invention is characterized in that the surface finishing is constituted by a metal coated film,

the metal coated film being provided by at least one means selected from a wet plating method, a vapor deposition method, an ion plating method, an arcing method and a sputtering method.

Thus, the surface finishing is constituted by the metal coated film. Therefore, it is possible to design and manufacture a watch case having a corrosion resistance, a heat resistance, a mechanical strength and the like and having a color tone such as a metal color having a sense of high grade and the high quality of an appearance, for example, a watch case body, a back cover, a bezel and the like in the same manner as in a general watch which is not the radio controlled watch. Thus, the design variation of the case in the radio controlled watch can be increased equivalently to the general watch.

In addition, such a metal coated film is formed by a wet plating method, a vapor deposition method, anion plating method, an arcing method and a sputtering method. Therefore, it is possible to correspond to the complicated shape of the watch case, and furthermore, to simplify a manufacturing process, thereby reducing a cost.

Furthermore, the radio controlled watch according to the present invention is characterized in that a surface of the non-magnetic member is subjected to the surface finishing.

Thus, the surface finishing is carried out over the surface of the non-magnetic member. Therefore, it is possible to design and manufacture a watch case having a corrosion resistance, a heat resistance, a mechanical strength and the like and having a color tone such as a metal color having a sense of high grade and the high quality of an appearance, for example, a watch case body, a back cover, a bezel and the like in the same manner as in a general watch which is not the radio controlled watch. Consequently, the design variation of the case in the radio controlled watch can be increased equivalently to the general watch.

In addition, a radio controlled watch according to the present invention comprises:

an antenna for receiving a radio wave including time information;

a watch device for causing a display portion to display time information such as a present time by the radio wave received by the antenna; and

a watch case for accommodating the antenna and the watch device,

wherein the watch case is constituted by a metal.

Moreover, the radio controlled watch according to the present invention is characterized in that the antenna is provided in contact with an internal surface of the watch case.

Furthermore, the radio controlled watch according to the present invention is characterized in that the antenna is provided apart from an internal surface of the watch case.

Thus, the watch case is constituted by a metal and a distance between the antenna and the watch case, that is, a back body thickness T1 of the watch case body of the watch case, a back cover thickness T2 of the back cover of the watch case, a gap D1 from the internal surface of the watch case body to the antenna, and a gap D2 from the internal surface of the back cover to the antenna are set based on a receiving sensitivity. Consequently, it is possible to reduce the disturbance of a resonant phenomenon in the vicinity of the antenna which is caused by a metal material. Therefore, it is possible to enhance the receiving sensitivity also in the metal watch case. Thus, sit is possible to use a metal having the excellent quality of an appearance such as titanium, a titanium alloy, stainless steel or tantalum carbide which has a low receiving sensitivity, a low frequency selectivity and a high electric resistivity as the watch case, for example, the watch case body, the back cover, the bezel or the like without sacrificing the receiving sensitivity. Consequently, it is possible to enhance functions in respect of the mechanism and appearance of the watch case.

In addition, the radio controlled watch according to the present invention is characterized in that the watch case and the antenna are set in such a manner that a body thickness T1 of a watch case body of the watch case ranges from 300 μm to 5000 μm.

Moreover, the radio controlled watch according to the present invention is characterized in that the watch case and the antenna are set in such a manner that the body thickness Ti of the watch case body of the watch case ranges from 500 μm to 2000 μm.

Thus, the body thickness T1 of the watch case body of the watch case is set to be 300 μm to 5000 μm. Consequently, it is possible to have a high gain of the antenna and an excellent receiving sensitivity and to maintain such a strength as to be usable as the watch case or the like.

In particular, the body thickness T1 of the watch case body of the watch case is set to be 500 μm to 2000 μm. Consequently, it is possible to have a high gain of the antenna and an excellent receiving sensitivity and to maintain such a strength as to be usable as the watch case or the like. In addition, it is possible to obtain the optimum watch case body which considers an appearance, a workability, a corrosion resistance and the like for the watch case.

Furthermore, the radio controlled watch according to the present invention is characterized in that the watch case and the antenna are set in such a manner that a gap D1 from an internal surface of the watch case body of the watch case to the antenna ranges from 0 to 40000 μm.

In addition, the radio controlled watch according to the present invention is characterized in that the watch case and the antenna are set in such a manner that the gap D1 from the internal surface of the watch case body of the watch case to the antenna ranges from 500 μm to 10000 μm.

By setting the positional relationship between the watch case body of the watch case and the antenna, that is, the gap D1 from the internal surface of the watch case body of the watch case to the antenna to be 0 to 40000 μm, thus, it is possible to obtain a high gain of the antenna and an excellent receiving sensitivity.

By setting the gap D1 from the internal surface of the watch case body of the watch case to the antenna to be 500 μm to 10000 μm, particularly, it is possible to maintain a high gain of the antenna, an excellent receiving sensitivity, a strength which is usable for the watch case and the like. In addition, it is possible to obtain the optimum watch case body which considers an appearance, a workability, a corrosion resistance and the like for the watch case.

Moreover, the radio controlled watch according to the present invention is characterized in that the watch case and the antenna are set in such a manner that a back cover thickness T2 of a back cover of the watch case ranges from 1001 μm to 5000 μm.

Furthermore, the radio controlled watch according to the present invention is characterized in that the watch case and the antenna are set in such a manner that the back cover thickness T2 of the back cover of the watch case ranges from 300 μm to 2000 μm.

By setting the back cover thickness T2 of the back cover of the watch case to be 100 μm to 5000 μm, thus, it is possible to maintain a high gain of the antenna, an excellent receiving sensitivity, a strength which is usable for the watch case and the like.

By setting the back cover thickness T2 of the back cover of the watch case to be 300 μm to 2000 μm, particularly, it is possible to maintain a high gain of the antenna, an excellent receiving sensitivity, a strength which is usable for the watch case and the like. In addition, it is possible to obtain the optimum back cover of the watch case which considers an appearance, a workability, a corrosion resistance and the like for the watch case.

In addition, the radio controlled watch according to the present invention is characterized in that the watch case and the antenna are set in such a manner that a gap D2 from an internal surface of the back cover of the watch case to the antenna ranges from 0 to 5000 μm.

Moreover, the radio controlled watch according to the present invention is characterized in that the watch case and the antenna are set in such a manner that the gap D2 from the internal surface of the back cover of the watch case to the antenna ranges from 100 μm to 700 μm.

By setting the positional relationship between the back cover of the watch case and the antenna, that is, the gap D2 from the internal surface of the back cover of the watch case to the antenna to be 0 to 5000 μm, thus, it is possible to obtain a high gain of the antenna, an excellent receiving sensitivity, a strength which is usable for the watch case and the like.

By setting the gap D2 from the internal surface of the back cover of the watch case to the antenna to be 100 μm to 700 μm, particularly, it is possible to maintain a high gain of the antenna, an excellent receiving sensitivity, a strength which is usable for the watch case and the like. In addition, it is possible to obtain the optimum back cover of the watch case which considers an appearance, a workability, a corrosion resistance and the like for the watch case.

Moreover, the radio controlled watch according to the present invention is characterized in that the watch case body of the watch case is formed by at least one material selected from titanium, a titanium alloy, stainless steel, tungsten carbide and tantalum carbide.

Furthermore, the radio controlled watch according to the present invention is characterized in that the back cover of the watch case is formed by at least one material selected from titanium, a titanium alloy, stainless steel, tungsten carbide and tantalum carbide.

By setting the distance between the antenna and the watch case, that is, the body thickness T1 of the watch case body of the watch case, the back cover thickness T2 of the back cover of the watch case, the gap D1 from the internal surface of the watch case body to the antenna, and the gap D2 from the internal surface of the back cover to the antenna based on the receiving sensitivity as described above, it is possible to reduce the disturbance of a resonant phenomenon in the vicinity of the antenna which is caused by a metal material.

Accordingly, it is possible to use a metal having the excellent quality of an appearance such as titanium, a titanium alloy, stainless steel or tantalum carbide which has a low receiving sensitivity, a low frequency selectivity and a high electric resistivity as the watch case, for example, the watch case body, the back cover, the bezel or the like without sacrificing the receiving sensitivity. Consequently, it is possible to enhance functions in respect of the mechanism and appearance of the watch case.

Moreover, the radio controlled watch according to the present invention is characterized in that the watch case body of the watch case is formed by at least one material selected from gold, silver, copper, brass, aluminum, magnesium, zinc and their alloy.

Furthermore, the radio controlled watch according to the present invention is characterized in that the watch case body of the watch case is formed by bonding at least two materials selected from gold, silver, copper, brass, aluminum, magnesium, zinc and their alloy.

In addition, the radio controlled watch according to the present invention is characterized in that the back cover of the watch case is formed by at least one material selected from gold, silver, copper, brass, aluminum, magnesium, zinc and their alloy.

Moreover, the radio controlled watch according to the present invention is characterized in that the back cover of the watch case is formed by bonding at least two materials selected from gold, silver, copper, brass, aluminum, magnesium, zinc and their alloy.

Thegold, thesilver, the copper, the brass, the aluminum, the magnesium or their alloy is a metal having an electric resistivity of 7.0 μΩ-Cm or less. By using such a metal for the watch case, for example, the watch case body, the back cover, the bezel or the like, it is possible to increase both a receiving sensitivity and a frequency selectivity and to reduce the disturbance of a resonant phenomenon in the vicinity of an antenna which is caused by a metal material. Thus, it is possible to obtain a sufficient receiving sensitivity also in a metal watch case.

Furthermore, the radio controlled watch according to the present invention is characterized in that the watch case body of the watch case is formed of a hard metal.

In addition, the radio controlled watch according to the present invention is characterized in that the back cover of the watch case is formed of a hard metal.

By constituting the watch case, for example, the watch case body, the back cover, the bezel and the like by the hard metal, thus, it is possible to enhance the receiving sensitivity also in a watch case using a metal. In addition, it is possible to prevent an abrasion and a damage and to enhance a mechanical strength and the like.

Moreover, the radio controlled watch according to the present invention is characterized in that at least one of the watch case body and the back cover of the watch case is subjected to a surface treatment and/or a hardening treatment.

Thus; the surface treatment and/or the hardening treatment are/is carried out over the watch case body or the back cover in the watch case. Therefore, it is possible to design and manufacture a watch case having a corrosion resistance, a heat resistance, a mechanical strength and the like and having a color tone such as a metal color having a sense of high grade and the high quality of an appearance, for example, a watch case body, a back cover, a bezel and the like in the same manner as in a general watch which is not the radio controlled watch. Thus, the design variation of the case in the radio controlled watch can be increased equivalently to the general watch.

Furthermore, the radio controlled watch according to the present invention is characterized in that an internal surface of the watch case body of the watch case and an external side surface of the antenna are provided in substantially parallel with each other as seen on a plane.

In addition, the radio controlled watch according to the present invention is characterized in that one end face of both ends in an axial direction of the antenna is provided in substantially parallel with an internal surface of the back cover of the watch case.

Moreover, the radio controlled watch according to the present invention is characterized in that an external side surface of the antenna is provided substantially perpendicularly to an internal surface of the back cover of the watch case.

More specifically, even if the antenna is provided in a vertical erecting state (in a vertical direction) in the watch case, it is possible to reduce the disturbance of a resonant phenomenon in the vicinity of an antenna which is caused by a metal material by setting the distance between the antenna and the watch case, that is, the body thickness T1 of the watch case body of the watch case, the back cover thickness T2 of the back cover of the watch case, the gap D1 from the internal surface of the watch case body to the antenna, and the gap D2 from the internal surface of the back cover to the antenna based on the receiving sensitivity as described above.

Furthermore, the radio controlled watch according to the present invention is characterized in that an internal surface of the back cover of the watch case and an external side surface of the antenna are provided in substantially parallel with each other.

In addition, the radio controlled watch according to the present invention is characterized in that one end face of both ends in an axial direction of the antenna is provided substantially perpendicularly to an internal surface of the back cover of the watch case.

Moreover, the radio controlled watch according to the present invention is characterized in that an internal surface of the watch case body of the watch case and an external side surface of the antenna are provided in substantially parallel with each other as seen on a plane.

More specifically, even if the antenna is provided to be laid in a horizontal direction in the watch case, it is possible to reduce the disturbance of a resonant phenomenon in the vicinity of the antenna which is caused by a metal material by setting the distance between the antenna and the watch case, that is, the body thickness T1 of the watch case body of the watch case, the back cover thickness T2 of the back cover of the watch case, the gap D1 from the internal surface of the watch case body to the antenna, and the gap D2 from the internal surface of the back cover to the antenna based on the receiving sensitivity as described above.

Furthermore, the radio controlled watch according to the present invention is characterized in that the back cover of the watch case takes a two-dimensional planar shape.

When the rising portion is not formed on the back cover but the internal surface is caused to be flat and the back cover is caused to have the two-dimensional planar shape, it is possible to more reduce the disturbance of a resonant phenomenon around the antenna and to more enhance the receiving sensitivity as compared with those in the case in which the rising portion is provided.

In addition, the radio controlled watch according to the present invention is characterized in that at least one non-magnetic member having an electric resistivity of 7.0 μΩ-Cm or less is fixed to the internal surface of the watch case.

Thus, the non-magnetic member having the electric resistivity of 7.0 μΩ-Cm or less is provided on the internal surface of the watch case. Consequently, it is possible to reduce the disturbance of a resonant phenomenon in the vicinity of the antenna which is caused by a metal material. Therefore, it is possible to obtain a sufficient receiving sensitivity also in a metal watch case.

By using the non-magnetic member having the electric resistivity of 7.0 μΩ-Cm or less as a non-magnetic member to be fixed to the watch case, for example, the watch case body and the internal surface of the back cover in the radio controlled watch, consequently, it is possible to use a metal having the excellent quality of an appearance such as titanium, a titanium alloy, stainless steel or tantalum carbide which has a low receiving sensitivity, a low frequency selectivity and a high electric resistivity as the watch case, for example, the watch case body and the back cover without sacrificing the receiving sensitivity. Thus, it is possible to enhance functions in respect of the mechanism and appearance of the watch case.

Moreover, the radio controlled watch according to the present invention is characterized in that the non-magnetic member is constituted by at least one material selected from gold, silver, copper, brass, aluminum, magnesium, zinc and their alloy.

Furthermore, the radio controlled watch according to the present invention is characterized in that the non-magnetic member is formed by bonding at least two materials selected from gold, silver, copper, brass, aluminum, magnesium and their alloy.

The gold, the silver, the copper, the brass, the aluminum, the magnesium or their alloy is a metal having an electric resistivity of 7.0 μΩ-Cm or less. By using such a metal as the non-magnetic member to be fixed to the watch case body of the watch case or the internal surface of the back cover, it is possible to increase both a receiving sensitivity and a frequency selectivity and to reduce the disturbance of a resonant phenomenon in the vicinity of the antenna which is caused by a metal material. Thus, it is possible to obtain a sufficient receiving sensitivity also in a metal watch case.

In addition, the radio controlled watch according to the present invention is characterized in that the antenna is constituted by a magnetic core member and a coil wound around the magnetic core member in plural turns, and
a member of the watch case onto which the antenna is projected in parallel along at least one plane including an axis of the magnetic core member or a portion onto which the projected member of the watch case is projected is constituted by the non-magnetic member.

Moreover, the radio controlled watch according to the present invention is characterized in that the antenna is constituted by a magnetic core member and a coil wound around the magnetic core member in plural turns, and
a member of the watch case opposed to at least one end in an axial direction of the antenna or a portion opposed to the member of the watch case opposed to the end in the axial direction is constituted by the non-magnetic member.

The non-magnetic member is provided in such a position. Consequently, the non-magnetic member is positioned in the vicinity of the antenna so that it is possible to reduce the disturbance of a resonant phenomenon in the vicinity of the antenna which is caused by a metal material. Therefore, it is possible to obtain a sufficient receiving sensitivity also in a metal watch case.

Furthermore, a radio controlled watch according to the present invention comprises:

an antenna for receiving a radio wave including time information;

a watch device for causing a display portion to display time information such as a present time by the radio wave received by the antenna;

an antimagnetic plate for preventing an influence of an external magnetism; and

a watch case for accommodating the antenna, the watch device and the antimagnetic plate,

wherein the antimagnetic plate provided in the watch case has an opening portion in an opposed part to the antenna.

Thus, the antimagnetic plate provided in the watch case has the opening portion in the opposed part to the antenna. Consequently, the antenna can receive a radio wave through the opening portion without the influence of the antimagnetic plate. Thus, it is possible to protect the watch device from an external magnetism also in the radio controlled watch without deteriorating a radio wave receiving performance. Thus, it is possible to enhance precision in the watch without an influence on the driving operation of a hand.

In addition, the radio controlled watch according to the present invention is characterized in that the antenna is constituted by a magnetic core member and a coil wound around the magnetic core member in plural turns, and

an opening portion is provided on the antimagnetic plate in a position in which the antenna is projected in parallel along at least one plane including an axis of the magnetic core member.

Furthermore, the radio controlled watch according to the present invention is characterized in that the antenna is constituted by a magnetic core member and a coil wound around the magnetic core member in plural turns, and

an opening portion is provided on the antimagnetic plate in an opposed position to at least one end in an axial direction of the antenna.

The opening portion is provided on the antimagnetic plate in such a position, that is, a relative position to the antenna. Consequently, the antenna can receive a radio wave through the opening portion without the influence of the antimagnetic plate. Thus, it is possible to protect the watch device from an external magnetism also in the radio controlled watch without deteriorating a radio wave receiving performance. Consequently, it is possible to enhance precision in the watch without an influence on the driving operation of a hand.

In addition, the radio controlled watch according to the present invention is characterized in that the antenna is provided to be positioned on an outside of the antimagnetic plate.

Moreover, the radio controlled watch according to the present invention is characterized in that the antenna has at least a part protruded from the opening portion of the antimagnetic plate and positioned on an internal surface side of a case body of the watch case.

Furthermore, the radio controlled watch according to the present invention is characterized in that the antenna has at least a part protruded from the opening portion of the antimagnetic plate and positioned on a back cover side of the watch case.

In addition, the radio controlled watch according to the present invention is characterized in that the antenna has at least a part protruded from the opening portion of the antimagnetic plate and positioned on a display plate side.

The antenna is provided in such a position that it is partially or wholly protruded from the opening portion. Consequently, the antenna can receive a radio wave without the influence of the antimagnetic plate. Thus, it is possible to protect the watch device from an external magnetism also in the radio controlled watch without deteriorating a radio wave receiving performance. Thus, it is possible to enhance precision in the watch without an influence on the driving operation of a hand.

Moreover, the radio controlled watch according to the present invention is characterized in that the antimagnetic plate is formed by at least one material selected from pure iron and Permalloy.

Thus, the antimagnetic plate is formed of the pure iron or the Permalloy. Therefore, a high magnetic permeability can be obtained and the watch device can be protected from an external magnetism, and precision in the watch can be enhanced without an influence on the driving operation of a hand.

Furthermore, the radio controlled watch according to the present invention is characterized in that anon-magnetic member having an electric resistivity of 7.0 μΩ-Cm or less is provided on an internal surface of the antimagnetic plate.

By such a structure, the non-magnetic member having the electric resistivity of 7.0 μΩ-Cm or less is provided on the internal surface of the antimagnetic plate. Therefore, the gain of the antenna can be increased and both a receiving sensitivity and a frequency selectivity can be enhanced so that a receiving performance and precision in the watch can be improved.

In addition, the radio controlled watch according to the present invention is characterized in that the non-magnetic member is provided in the opening portion of the antimagnetic plate.

Thus, the non-magnetic member is provided in the opening portion of the antimagnetic plate in a position corresponding to the antenna. Consequently, both a receiving sensitivity and a frequency selectivity can be enhanced and the gain of the antenna can be increased, and both the receiving sensitivity and the frequency selectivity can be improved so that a receiving performance and precision in the watch can be enhanced.

Moreover, the radio controlled watch according to the present invention is characterized in that the non-magnetic member is constituted by at least one material selected from gold, silver, copper, brass, aluminum, magnesium, zinc and their alloy.

Furthermore, the radio controlled watch according to the present invention is characterized in that the non-magnetic member is formed by bonding at least two materials selected from gold, silver, copper, brass, aluminum, magnesium, zinc and their alloy.

The gold, the silver, the copper, the brass, the aluminum, the magnesium or their alloy is a metal having an electric resistivity of 7.0 μΩ-Cm or less. By using such a metal as the non-magnetic member to be fixed to the watch case body of the watch case or the internal surface of the back cover, it is possible to increase the gain of the antenna, to enhance both a receiving sensitivity and a frequency selectivity and to improve a receiving performance and precision in the watch.

In addition, the radio controlled watch according to the present invention is characterized in that the non-magnetic member has a rising portion erected in a direction of the display plate, and

the rising portion abuts on a part of the watch case, thereby regulating a rotation of the antimagnetic plate.

By such a structure, it is possible to stop the rotation of the antimagnetic plate, thereby positioning the antimagnetic plate easily, and to simply assemble the antenna, the watch case and the antimagnetic plate. Consequently, a manufacturing process can be simplified and a cost can be reduced.

In addition, a radio controlled watch according to the present invention comprises:

an antenna for receiving a radio wave including time information;

a watch device for causing a display portion to display time information such as a present time by the radio wave received by the antenna; and

a watch case for accommodating the antenna and the watch device,

wherein the watch case is constituted by an electrically non-conductive material or a material having a low electric resistivity, and

an exterior member formed by an electrically conductive material which is attached to an outside of the watch case is provided.

Moreover, the radio controlled watch according to the present invention is characterized in that the exterior member covers an external side surface of the watch case body of the watch case.

Furthermore, the radio controlled watch according to the present invention is characterized in that the exterior member covers an upper surface of a watch case body of the watch case.

By such a structure, the watch case for accommodating the antenna is formed by a material having an electrical non-conductivity or a low electric resistivity, and the exterior member attached to the outside of the watch case, particularly, the exterior member for covering the external side surface of the watch case body is electrically conductive, for example, a metal.

As compared with the case in which the watch case itself for accommodating the antenna is formed by a conductive material, accordingly, a distance between the antenna and the exterior member to be the electrical conductive material, for example, a metal can be increased. Consequently, the receiving failure of the antenna is caused with difficulty. Thus, the antenna can receive a radio wave well so that a receiving performance and precision in the watch can be enhanced.

By the conductive exterior member such as the metal, furthermore, an appearance having a sense of the metal can be given to the radio controlled watch. Consequently, a visual recognition is carried out as if the watch case is formed of a solid metal. Therefore, it is possible to prevent a sense of high grade and a fine appearance from being damaged by using a non-conductive material such as a synthetic resin for the watch case.

In addition, the radio controlled watch according to the present invention is characterized in that the electrically non-conductive material constituting the watch case is formed by at least one electrically non-conductive material selected from a synthetic resin, rubber and ceramic.

Thus, the watch case, for example, the watch case body, the back cover, the bezel and the like are constituted by the electrically non-conductive materials such as a synthetic resin, rubber or ceramic. Therefore, the antenna can receive a radio wave well so that a receiving performance and precision in the watch can be enhanced.

Furthermore, the radio controlled watch according to the present invention is characterized in that a material having a low electric resistivity which constitutes the watch case includes at least one material having a low electric resistivity which is selected from gold, silver, copper, brass, aluminum, magnesium and their alloy.

Thus, the watch case, for example, the watch case body, the back cover, the bezel and the like are constituted by the materials having low electric resistivities such as gold, silver, copper, brass, aluminum, magnesium or their alloy. Therefore, the antenna can receive a radio wave well so that a receiving performance and precision in the watch can be enhanced.

In addition, the radio controlled watch according to the present invention is characterized in that an electrically conductive material constituting the exterior member includes at least one electrically conductive material selected from stainless, titanium and a titanium alloy.

Thus, the exterior member can be constituted by the electrically conductive material such as stainless, titanium or a titanium alloy which is a metal having the excellent quality of an appearance. Therefore, it is possible to design and manufacture the exterior member in the same manner as in a general watch which is not the radio controlled watch. Thus, the design variation of the case in the radio controlled watch can be increased equivalently to the general watch.

### BRIEF DESCRIPTION OF THE DRAWINGS

FIG. 1 is a sectional view showing the structure of the case of a radio controlled watch according to an example of the present invention.

FIG. 2 is a chart for explaining an example of the calculation of the gain of an antenna indicative of the superiority or inferiority of a receiving state and a Q value.

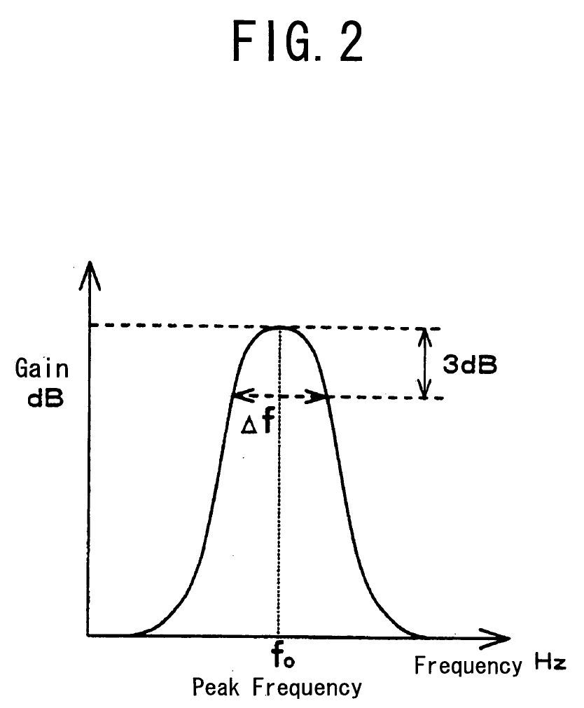

FIG. 3 is an explanatory view showing equipment for a receiving experiment using an exterior member for an experiment.

FIG. 4 is an exploded perspective view showing the structure of the case of a radio controlled watch according to another example of the present invention.

FIG. 5 is a sectional plan view taken along the axis of a stem in FIG. 4.

FIG. 6 is a sectional view showing the structure of the case of a radio controlled watch according to another example of the present invention.

FIG. 7 is a sectional view showing the structure of the case of a radio controlled watch according to another example of the present invention.

FIG. 8 is a sectional view showing the structure of the case of a radio controlled watch according to another example of the present invention.

FIG. 9 is a sectional view showing the structure of the case of a radio controlled watch according to another example of the present invention.

FIG. 10 is a plan view for explaining a state in which a watch case body and an antenna are set according to the present invention.

FIG. 11 is a sectional view for explaining a state in which a back cover and the antenna are set according to the present invention.

FIG. 12 is a chart showing a relationship between the gain of a receiving signal and the thickness of the body based on the result of an experiment.

FIG. 13 is a chart showing a relationship between the gain of the receiving signal and a distance from the antenna to the body based on the result of an experiment.

FIG. 14 is a chart showing a relationship between the gain of the receiving signal and the thickness of the back cover based on the result of an experiment.

FIG. 15 is a chart showing a relationship between the gain of the receiving signal and a distance from the antenna to the back cover based on the result of an experiment.

FIG. 16 is a sectional view showing the structure of the case of a radio controlled watch according to another example of the present invention.

FIG. 17 is a sectional view showing the structure of the case of a radio controlled watch according to another example of the present invention.

FIG. 18 is a sectional view showing the structure of the case of a radio controlled watch according to another example of the present invention.

FIG. 19 is a sectional view showing the structure of the case of a radio controlled watch according to another example of the present invention.

FIG. 20 is a plan view seen in the direction of the back cover of an antimagnetic plate illustrated in FIG. 19.

FIG. 21 is a sectional view showing the structure of the case of a radio controlled watch according to another example of the present invention.

FIG. 22 is a sectional view showing the structure of the case of a radio controlled watch according to another example of the present invention.

FIG. 23 is a sectional view showing the structure of the case of a radio controlled watch according to another example of the present invention.

FIG. 24 is a sectional view showing the structure of the case of a radio controlled watch according to a further example of the present invention.

FIG. 25 is a plan view seen in the direction of the back cover of an antimagnetic plate illustrated in FIG. 24.

FIG. 26 is a block diagram schematically showing the function of the radio controlled watch.

FIG. 27 is a sectional view showing a conventional example of the structure of a radio controlled watch using a metal in a part of a case.

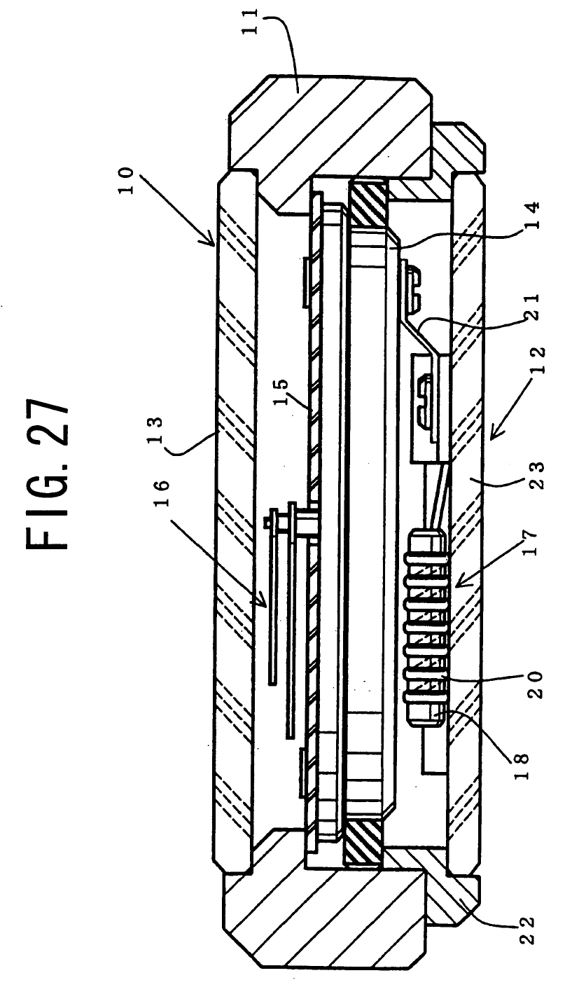

FIG. 28 is a sectional view showing a conventional example of the structure of a general watch using an antimagnetic plate.

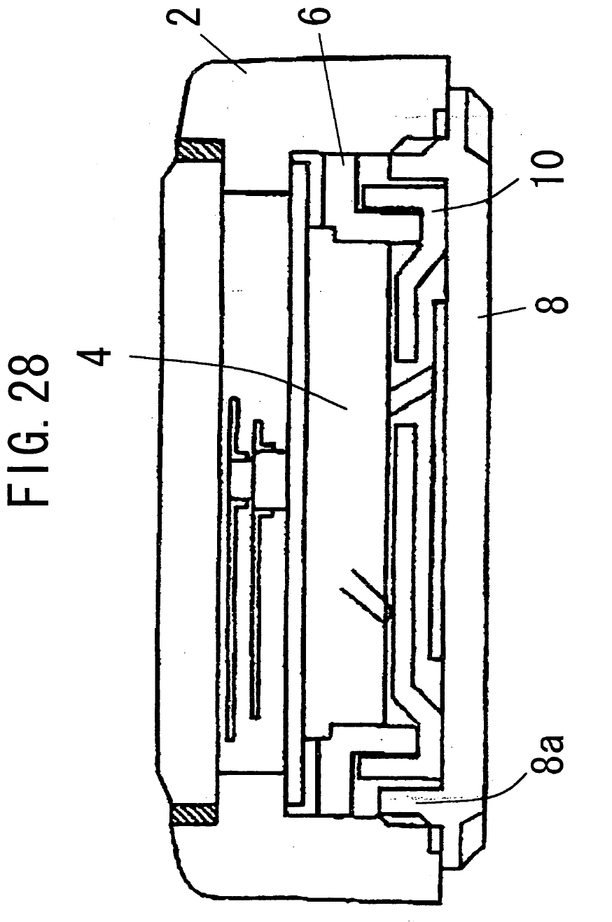

FIG. 29 is a sectional view showing a back cover according to an example of formation in which a non-magnetic member is formed by electroforming.

FIG. 30 is a schematic view for explaining a state in which the antenna of the radio controlled watch according to the present invention is provided.

### BEST MODE FOR CARRYING OUT THE INVENTION

An embodiment (example) of the present invention will be described below in more detail with reference to the drawings.

### EXAMPLE 1

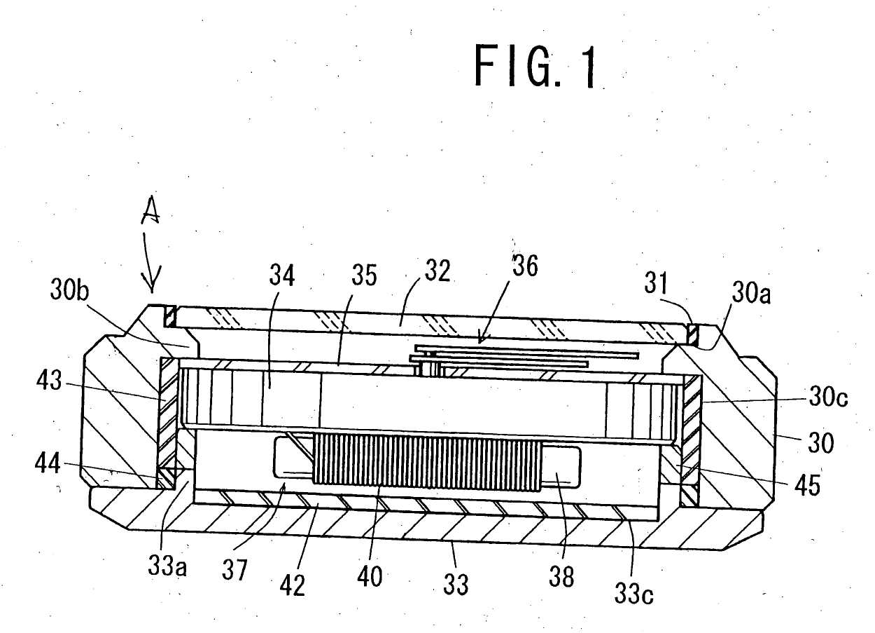

FIG. 1 is a sectional view showing the structure of the case of a radio controlled watch according to an example of the present invention.

As shown in FIG. 1, a watch case A is constituted by a watch case body 30, aback cover 33 attached to the lower surface of the watch case body 30, a bezel which is not shown, and the like.

The watch case body 30 has an substantially cylindrical shape, and a glass 32 is attached through a packing 31 to a shoulder portion 30a provided on the inner peripheral edge of an upper opening portion in the drawing. In addition, a back cover 33 is fixed to a lower opening portion in the drawing through means such as press fitting, screwing or a screw.

The back cover 33 shown in FIG. 1 is attached to the watch case body 30 by the press fitting. Furthermore, a packing 44 is interposed between a rising portion 33a and an inner side surface 30c of the watch case body 30. Moreover, the watch case body 30 is formed of a metal and a material thereof will be described below.

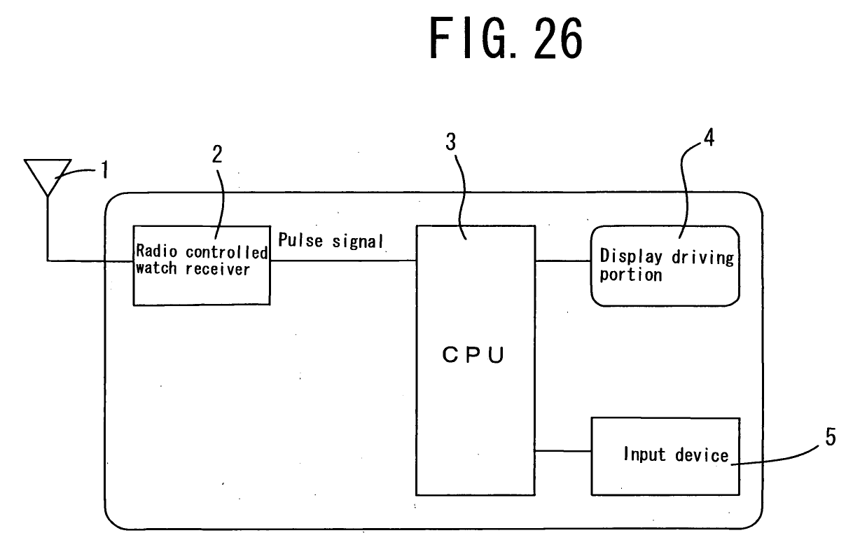

The watch case body 30 accommodates a movement 34 including the radio controlled watch receiver, the CPU, the display driving portion and the like which are shown in FIG. 26 described above. A dial plate 35 and a hand 36 which serve as timed is play portions are provided above the movement 34 in the drawing.

The movement 34 is positioned by the abutment of the dial plate 35 on the lower surface of an inner protruded portion 30b forming the shoulder 30a of the watch case body 30 in the drawing. Furthermore, the movement 35 is interposed between the dial plate 35 and a resin middle frame 45 provided on the upper surface of the rising portion 33a of the back cover 33 and is thus fixed.

Moreover, a predetermined space is provided between the movement 34 and the back cover 33, and an antenna 37 is provided in the space. The antenna 37 is constituted by a bar-shaped magnetic core member 38 formed by a ferrite material and a coil 40 wound around the magnetic core member 38, and is fixed to the lower surface of the movement 34.

In the present example, moreover, non-magnetic members 42 and 43 are provided on the inner side surface 30c of the watch case body 30 and the internal surface 33c of the back cover 33. The non-magnetic member 42 has the shape of a plate and is provided on the internal surface 33c at the inside of the rising portion 33a of the back cover 33 which is opposed to the movement 34. In addition, the non-magnetic member 42 is opposed to a plane including an axis AX of the magnetic core member 38, and furthermore, is provided in a position in which the antenna 37 is projected in parallel.

More specifically, in FIG. 1, the non-magnetic member 42 is opposed to a horizontal plane including the axis AX of the magnetic core member 38 and is provided in a position in which the antenna 37 is projected in parallel, that is, on the upper surface of the back cover 33.

However, the position of the provision is not restricted to that in FIG. 1 but the non-magnetic member may be disposed in a position in which the antenna 37 is projected onto the internal surface of the watch case in parallel along at least one plane including the axis AX of the magnetic core member 38, for example, the position of the watch case body 30 to be projected or the position of the back cover 33 to be projected.

Moreover, the non-magnetic member 43 has the shape of a ring along the inner side surface 30c of the watch case body 30 or has the shape of a curved plate constituting a part thereof, and is provided in a position opposed to an end in the axial direction of the antenna 37 (a relative position).

The non-magnetic members 42 and 43 are formed by materials having electric resistivities of 7.0 μΩ-Cm or less and materials thereof will be described below.

In the radio controlled watch having the structure described above, the CPU in the movement 34 operates the display driving portion, based on a standard electric wave received by the antenna 37, thereby driving to always correct the hand 36.

At this time, in the structure of the watch case according to the present example, the non-magnetic members 42 and 43 are provided between the watch case body 30 and the antenna 37 and between the back cover 33 and the antenna 37. Therefore, the disturbance of a resonant phenomenon in the vicinity of the antenna which is caused by the watch case body 30 and the back cover 33 which are formed of a metal can be reduced so that a receiving sensitivity can be enhanced.

1. An Experiment for Selecting the Materials of the Watch Case Body 30, the Back Cover 33 and the Non-Magnetic Members 42 and 43:

Next, description will be given to an experiment related to the selection of the materials of the watch case body 30, the back cover 33 and the non-magnetic members 42 and 43 and a result thereof.

1-1. Selection of a Metal Having a Small Reduction in a Receiving Sensitivity:

In order to select a metal having a small reduction in the receiving sensitivity of the antenna 37, first of all, an antenna for an experiment which has 2000 turns of a coil having a conductor diameter of 65 μm was disposed on a metal plate having a thickness of 0.5 mm and an experiment for transmitting a signal of 40 kHz from a transmitting antenna provided in a predetermined position was carried out.

The evaluation of a receiving state is carried out by comparing a gain to be the peak height of a received signal with a Q value=fo/Δf obtained from a frequency bandwidth Δf and a peak frequency fo.

It is indicated that the receiving sensitivity is more enhanced if the gain is increased, and a frequency selectivity is more enhanced if the Q value is increased.

As a result of the experiment, in the case in which the antenna is provided on gold, silver, copper, brass, aluminum, magnesium, zinc or their alloy, the gain was higher (the receiving sensitivity was higher) by 2 to 3 dB (decibels) as compared with the case in which the antenna is provided on titanium, a titanium alloy or stainless steel.

1-2. An Experiment for Selecting a Material Using an Exterior Member for an Experiment

Next, the same experiment was carried out by using an exterior member for an experiment corresponding to the watch case body 30 and the back cover 33.

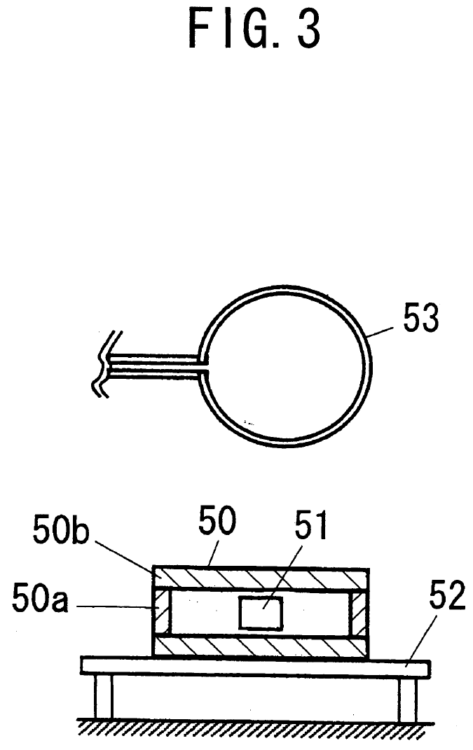

More specifically, as shown in FIG. 3, an exterior member 50 for an experiment corresponding to the watch case body 30 and the back cover 33 which accommodates an antenna 51 for an experiment corresponding to the antenna 37 was mounted on a resin plate 52. In this at ate, an electric wave having a constant frequency was transmitted from a transmitting antenna 53 provided in a predetermined position to measure the receiving state of the antenna 51 for an experiment.

As a result of the experiment, as shown in the following Table 1, when both a case portion 50a corresponding to the watch case body 30 and a cover portion 50b corresponding to the back cover 33 are formed of a metal such as stainless steel which is acknowledged to have a receiving sensitivity reduced, it was recognized that a Q value is decreased to be 5 which is not preferable for a radio controlled watch (Experimental example 1).

When the case potion 50a was formed of the metal such as stainless steel which is recognized to have the receiving sensitivity reduced and the cover portion 50b was formed of a metal such as brass which is recognized to have a high receiving sensitivity, the Q value was approximately 8 so that the receiving sensitivity could be enhanced (Experimental example 2).

Therefore, supposing use for the watch exterior member, the case portion 50a was maintained to be formed of the metal such as stainless steel and the cover portion 50b having an outside formed of a metal such as stainless steel and an inside formed of a metal such as brass was used. Consequently, the Q value was 8 to 9 which is set in a better state. In addition, the gain of the antenna could also be enhanced by 1 to 2 dB as compared with the case in which only the metal such as stainless steel is used (Experimental example 3).

TABLE 1
Result of experiment using exterior member for experiment

| | Case portion | Cover portion | |
|---|---|---|---|
| | 50a | 50b | Q value |
| Experimental | Metal such as | Metal such as | 5 |
| example 1 | stainless steel | stainless steel | |
| Experimental | Metal such as | Metal such as | Approximately 8 |
| example 2 | stainless steel | brass | |
| Experimental | Metal such as | Outside . . . metal | 8 to 9 |
| example 3 | stainless steel | such as | |
| | | stainless steel | |
| | | Inside . . . metal | |
| | | such as brass | |

From the results of the experiments, it could be verified that even if the watch case body 30 and the back cover 33 are formed of a metal having a receiving sensitivity reduced, where a metal having a high receiving sensitivity is provided on an inside, the receiving sensitivity of the antenna 37 provided on the inside of the watch case can be thus enhanced.

1-3. A Relationship Between an Electric Resistivity and a Receiving Sensitivity:

On the other hand, the electric resistivities of the metals used in the experiments were compared with each other.

Referring to titanium or stainless steel which reduces a receiving sensitivity, it was found that the electric resistivity is high, that is, 55 to 74 μΩ-Cm. Referring to aluminum having a high receiving sensitivity, it was found that the electric resistivity is low, that is, 2.69 μΩ-Cm.

In order to verify the relationship between the electric resistivity and the receiving sensitivity, metals to be provided on an outside and an inside are combined based on the electric resistivity. Consequently, it has been found that a high receiving sensitivity can be maintained even if the electric resistivity of the metal to be combined is high by setting the electric resistivity of a metal having a high receiving sensitivity to be 7 μΩ-Cm or less.

As a result, it could be verified that even if the watch case body 30 and the back cover 33 are formed of a metal having a receiving sensitivity reduced, a small Q value (a low frequency selectivity) and a high electric resistivity, for example, titanium, a titanium alloy, stainless steel or tantalum carbide which has the excellent quality of an appearance, where the non-magnetic members 42 and 43 are formed of a metal having a high receiving sensitivity, a great Q value (an excellent frequency selectivity), a low electric resistivity and an electric resistivity of 7 μΩ-Cm or less, for example, gold, silver, copper, brass, aluminum, magnesium, zinc or their alloy, the receiving sensitivity can be enhanced.

1-4. A Relationship Between Thicknesses and Receiving Sensitivities in the Non-Magnetic Members 42 and 43:

In order to examine the relationship between thicknesses and receiving sensitivities in the non-magnetic members 42 and 43, moreover, there was carried out an experiment for forming the case portion 50a and the cover portion 50b shown in FIG. 3 by stainless steel (an austenite type) and providing a thin aluminum material on the inside of the cover portion 50b to gradually increase a thickness thereof from zero (no aluminum material).

Consequently, it was found that the Q value is increased from 9.9 with a thickness of zero to 14.3 with a thickness of 500 μm, and that the exact value is maintained with an increase in the thickness when 14.6 is obtained with a thickness of 1000 μm. Furthermore, it was also found that the gain of the antenna is enhanced by approximately 3 dB with a thickness of 500 μm or more as compared with the case of the thickness of zero.

As a result, when the thickness of the aluminum material reaches 50 μm, the gain and the Q value are increased and thus become constant to be the greatest in a thickness of approximately 1000 μm. Consequently, it was found that the thicknesses of the non-magnetic members 42 and 43 are preferably set to be 50 μm or more.

Referring to the upper limit of the thickness, moreover, it is preferable that the thickness should be set to be 2000 μm or less in consideration of a distance between the watch case body 30 or the back cover 33 and the movement 34 or the antenna 37, an easiness to handle the non-magnetic members 42 and 43 in a manufacture and assembly or the like.

1-5. Consideration of the Result of an Experiment

Based on the result of each of the experiments or the like, it is the most preferable that the watch case body 30 and the back cover 33 should be formed of titanium, a titanium alloy, stainless steel, tungsten carbide or tantalum carbide which has a receiving sensitivity reduced, a small Q value (a low frequency selectivity) and the excellent quality of an appearance, the non-magnetic members 42 an 443 should be formed of gold, silver, copper, brass, aluminum, magnesium, zinc or their alloy which has a high receiving sensitivity, a great Q value (an excellent frequency selectivity), a low electric resistivity, and an electric resistivity of 7 μΩ-Cm or less, and furthermore, a thickness thereof-should be set to be 50 to 2000 μm.

Moreover, the non-magnetic members 42 and 43 do not need to be formed by only one of the metals but the same advantages could be obtained even if they were formed by bonding at least two of the metals through diffusion bonding, soldering, adhesion, caulking or the like.

Next, description will be given to the fixation of the watch case body 30 and the back cover 33 to the non-magnetic members 42 and 43.

In the case in which the watch case body 30 and back cover 33 and the non-magnetic members 42 and 43 are formed as separate components respectively, they are usually bonded through press fitting, caulking, welding, solderomg or an adhesive.

Moreover, the non-magnetic members 42 and 43 maybe bonded and fixed integrally in the stage of the materials of the watch case body 30 and the back cover 33, and shapes maybe then arranged.

In this case, there is used a clad material, which is heated, diffused and bonded in a state that the non-magnetic member formed of gold, silver, copper, brass, aluminum, magnesium, zing or their alloy is pressed in contact with the materials of the watch case body 30 and the back cover 33 which are formed of titanium, a titanium alloy, stainless steel or the like, and furthermore, bonded through rolling to have a predetermined thickness.

The watch case body 30 and the back cover 33 are formed by the clad material, and the watch case body 30 and back cover 33 and the non-magnetic members 42 and 43 are thus formed in an integral bonding state.

Moreover, it is also possible to form and fix the non-magnetic members 42 and 43 so as to be stuck to the watch case body 30 and the back cover 33.

In this case, the non-magnetic members 42 and 43 are formed in the predetermined positions of the watch case body 30 and the back cover 33 by electroforming using wet plating, a metal spraying method or the like.

Referring to the electroforming, description will be given by taking, as an example, the case in which copper is deposited on the back cover 33 constituted by stainless steel to form the non-magnetic member 42.

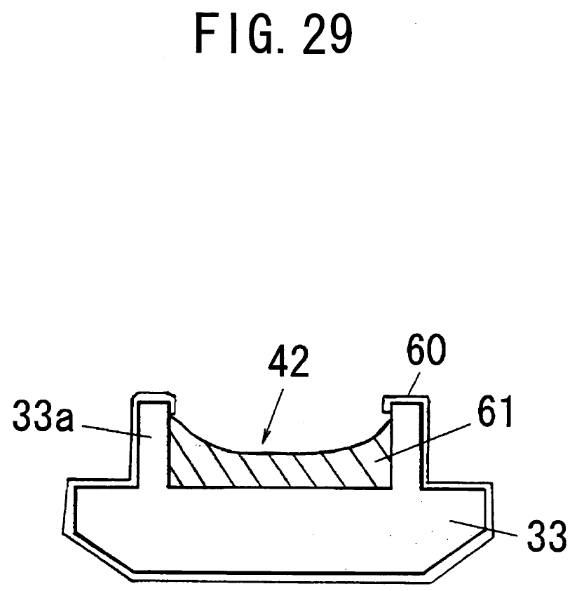

First of all, as shown in FIG. 29, a mask 60 constituted by an organic materials such as an epoxy resin is formed on the surface of the back cover 33 excluding a predetermined portion on the inside of the rising portion 33a of the back cover 33.

Next, electrolytic degreasing is carried out over the internal surface of the back cover 33 on which the mask 60 is not formed and washing with water is performed. Then, a cathode is connected to the back cover 33 and the electroforming is carried out in a copper sulfate bath to deposit a copper 61.

At this time, the composition and condition of the bath is set in the following manner.

250 g/l (litter) of copper sulfate, 60 g/l of sulfuric acid,

Temperature of 20 to 50° C.,

Current density of 2 to 20 A/dm²,

Time of 20 to 30 hours (which is set corresponding to a thickness of deposition. On this condition, a thickness of approximately 150 μm is obtained in six hours.), and

pH of 0.8 to 1.1.

After the copper 61 is thus deposited to have a predetermined thickness, the back cover 33 is immersed in an organic solvent to peel the mask 60. Thereafter, the back cover 33 is washed with water and is dried so that the non-magnetic member 42 can be formed in the predetermined position of the back cover 33.

While the non-magnetic members 43 and 42 are provided on the watch case body 30 and the back cover 33 respectively in the case structure shown in FIG. 1, a receiving sensitivity can be increased even if the non-magnetic member is simply provided on either the watch case body 30 or the back cover 33.

Accordingly, it is not necessary to always provide the non-magnetic member on both the watch case body 30 and the back cover 33.

Moreover, it is also possible to have such a structure as to provide a resin plate between the non-magnetic members 42 and 43 and the antenna 37 or to cover the surfaces of the non-magnetic members 42 and 43 with a resin layer, thereby preventing the antenna 37 and the non-magnetic members 42 and 43 from coming in contact with each other to damage the antenna 37.

According to the example 1, it is possible to increase the receiving sensitivity without using the special structure of a glass or the like for the structure of the watch case, for example, the watch case body 30 and the back cover 33. Therefore, it is possible to provide a radio controlled watch for receiving an electric wave including time information or the like without any hindrance in respect of carry.

Moreover, titanium, stainless steel or the like can be used for the watch case such as the watch case body 30 and the back cover 33. Consequently, it is possible to employ a case structure having the stable quality of water proofness and the quality of an appearance having a sense of high grade.

Furthermore, it is possible to design and manufacture the watch case such as the watch case body 30 and the back cover 33 in the same manner as that in a general watch which is not the radio controlled watch. Consequently, it is possible to increase the design variation of the case in the radio controlled watch equivalently to the general watch.

### EXAMPLE 2

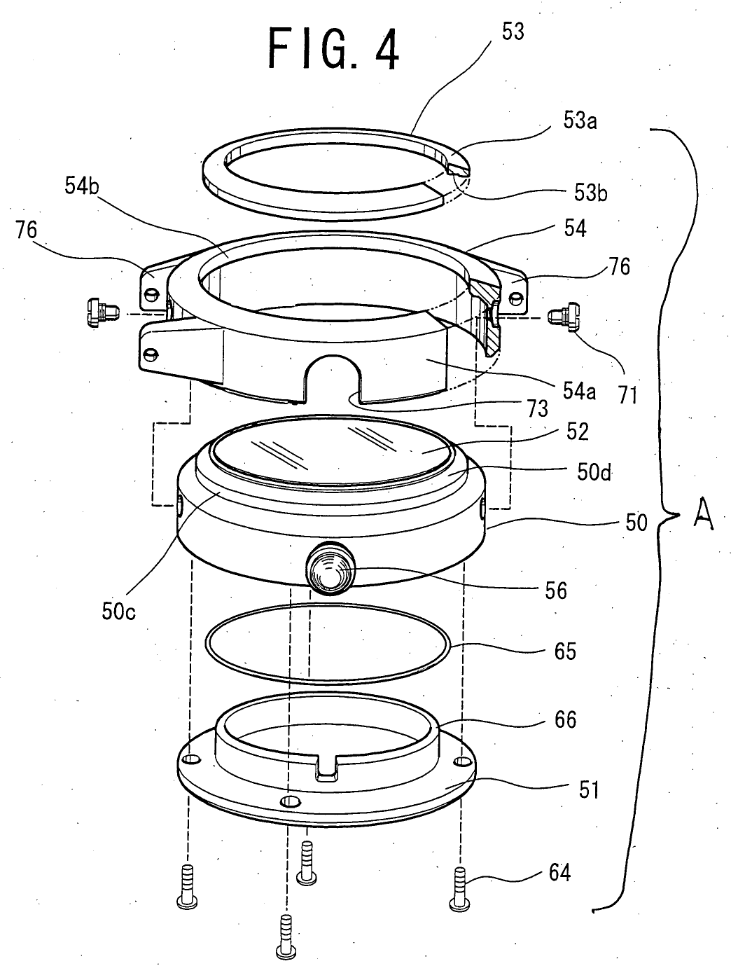

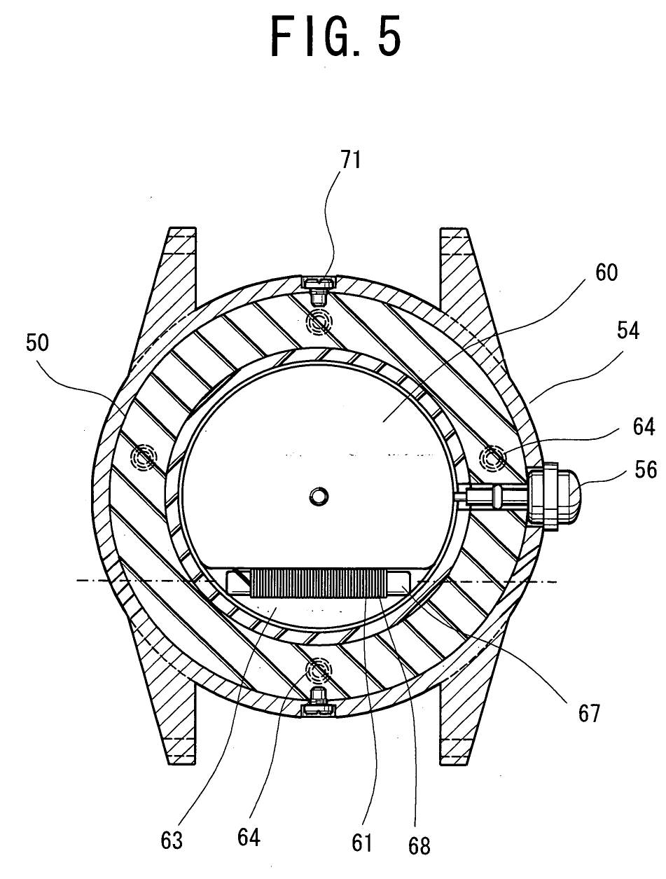

FIG. 4 is an exploded perspective view showing the case structure of a radio controlled watch according to another example of the present invention, and FIG. 5 is a sectional plan view taken along the axis of a stem.

The radio controlled watch according to the present example has two sets including a first exterior member 53 and a second exterior member 54 in a watch case A constituted by a watch case body 50, a back cover 51 and a wind shield 52.

In the present example, a structure in which a resin plate is provided between the non-magnetic members 42 and 43 and the antenna 37, and the surfaces of the non-magnetic members 42 and 43 are covered with a resin layer to prevent the antenna 37 and the non-magnetic members 42 and 43 from coming in contact with each other to damage the antenna 37 as in the example 1 is applied to the watch case.

More specifically, an electric non-conductive material such as a resin plate or a material having a low electric resistivity is used and applied to the watch case body 50 and the back cover 51, and the antenna is surrounded by these members, thereby preventing the damage of the antenna.

The watch case body 50 and the back cover 51 are formed by an electric non-conductive material such as a synthetic resin, rubber or ceramic or a material having a low electric resistivity such as gold, silver, copper, brass, aluminum, magnesium or their alloy. Furthermore, the wind shield 52 is formed by a glass to be a non-conductive material and is fixed to the shoulder portion of the watch case body 50 through a packing.

As shown in FIG. 4, the watch case body 50 has a stem 56 protruded cylindrically. In the case, a dial plate, a hand (not shown), and a movement 60 and a bar antenna 61 are accommodated as shown in FIG. 5.

The dial plate is formed by a non-conductive material such as a synthetic resin or ceramic. The movement 60 is provided with a shoulder portion 63 including a large lower part having a small diameter. The back cover 51 has a ring-shaped projection 66 and is fixed to a body through a packing 65 with a screw 64, and the ring-shaped projection 66 pushes up the shoulder portion 63 of the movement 60 to press and fix the movement and the dial plate to the shoulder portion of the watch case body 50.

The bar antenna 61 is constituted by a magnetic core member 67 and a coil 68 wound therearound and is bonded to the lower part of the large shoulder portion 63 of the movement 60 in parallel with the stem 56. That is, the bar antenna is accommodated in a lower position in a lower part in the case as shown in FIG. 5.

The first exterior member 53 and the second exterior member 54 are formed by a thin conductive material such as stainless, titanium or a titanium alloy.

As shown in FIG. 4, the first exterior member 53 has the shape of a ring-like disk and includes a slant face 53a provided outward and downward in an upper part and a shoulder portion 53b on a lower surface, and is bonded to a plane portion 50d of a ring-shaped protruded portion on the upper surface of the watch case body 50.

On the other hand, the second exterior member 54 is constituted by a side surface covering portion 54a having a cylindrical shape and covering the side surface of the body, and an inward protruded engaging portion 54b in an upper part. In addition, the upper surface of the engaging portion 54b is a slant face having the same inclination as that of the slant face 53a of the first exterior member 53 and an appearance is thus arranged.

As shown in FIG. 4, moreover, a band coupling leg portion 76 is formed on both ends. The side surface covering portion 54a is fixed to the side surface of the watch case body 50 with a screw 71. Moreover, the side surface covering portion 54a is provided with an opening portion 73 into which the stem 56 is protruded. The engaging portion 54b is engaged with a shoulder portion 50c of the watch case body 50 in pressure contact.

The side surface covering portion 54a has a small thickness in a radial direction and the watch case body 50 has a great thickness. Accordingly, the side surface covering portion 54a is provided greatly apart from the bar antenna 61.

Although the body has a great thickness, particularly, the side surface covering portion 54a of the second exterior member 54 is so large as to cover the side surface of the watch case body 50, thus, a receiving fault can be extremely lessened.

According to the example 2, the watch case such as the watch case body 50 and the back cover 51, which accommodate the antenna 61, is formed by an electric non-conductive material or a material having a low electric resistivity. In addition, the first exterior member 53 and the second exterior member 54 which are attached to the outside of these watch cases, particularly, the second exterior member 54 for covering the outer side surface of the watch case body is electrically conductive, for example, a metal.

As compared with the case in which the watch case itself for accommodating the antenna 61 is formed by a conductive material, accordingly, a distance between the antenna 61 and the first exterior member 53 and second exterior member 54 to be electrically conductive, for example, metals can be increased. Therefore, the receiving fault of the antenna 61 is caused with difficulty. Consequently, the antenna 61 can receive an electric wave well and a receiving performance and precision in the watch can be enhanced.

In addition, an electrical non-conductive material such as a resin plate or a material having a low electric resistivity is used and applied to the watch case body 50 and the back cover 51, and the antenna is surrounded by these members. Consequently, the damage of the antenna can be prevented.

Furthermore, an appearance having a sense of a metal is given to the radio controlled watch by the first exterior member 53 and the second exterior member 54 which are conductive, for example, metals. Consequently, the watch case is visually recognized as a solid metal. Although a non-conductive material such as a synthetic resin is used for the watch case, thus, a sense of high grade and a fine sight can be prevented from being damaged.

### EXAMPLE 3

Based on the result of “1. An experiment for selecting the materials of the watch case body 30, the back cover 33 and the non-magnetic members 42 and 43” according to the example 1, where the watch case body and the back cover is formed by a non-magnetic member such as gold, silver, copper, brass, aluminum, magnesium, zinc or their alloy which has an electric resistivity of 7 μΩ-Cm or less, a reduction in a receiving sensitivity can be suppressed and a metal watch case can be used for a radio controlled watch.

If a part of the watch case body and the back cover is formed by the non-magnetic member, moreover, it is possible to bring a receiving sensitivity into an excellent state even if the other portions are formed by titanium, a titanium alloy, stainless steel, tungsten carbide, tantalum carbide or the like.

Furthermore, the non-magnetic member does not need to be formed by only one of the metals but the same advantages can be obtained even if the watch case or a part thereof is formed by bonding at least two of the metals through diffusion bonding, soldering, adhesion, caulking or the like.

Next, description will be given to an example based on the result of the experiment described above or the like.

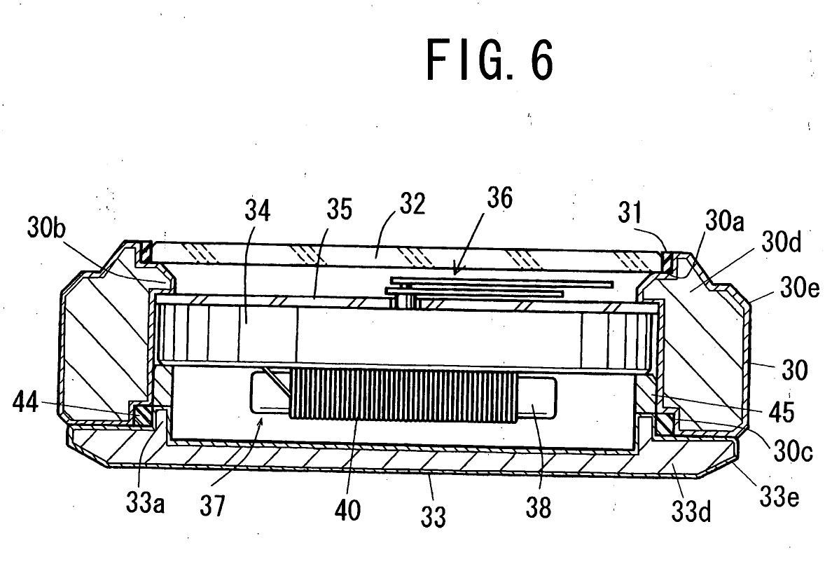

FIG. 6 is a sectional view showing a radio controlled watch case according to another example of the present invention.

A watch case body 30 has an almost cylindrical shape, and a glass 32 is attached through a packing 31 to a shoulder portion 30a provided on the inner peripheral edge of an upper opening portion in the drawing. In addition, a back cover 33 is attached to a lower opening portion in the drawing by means such as press fitting, screwing or a screw.

The back cover 33 shown in FIG. 6 is attached to the watch case body 30 by the press fitting, and a packing 44 is interposed between a rising portion 33a and an inner side surface 30c of the watch case body 30.

The watch case body 30 and the back cover 33 according to the present example are formed by body portions 30d and 33d constituted by a brass material to be a non-magnetic member having an electric resistivity of 7.0 μΩ-Cm or less which brings the receiving sensitivity into an excellent state in the experiment described above and mirror finishing is carried out, and plated layers 30e and 33e such as Pd are then formed on surfaces by wet plating and are thus finished.

The plated layers 30e and 33e of the watch case body 30 and the back cover 33 are formed by the wet plating as will be described below.

In order to form a substrate plated layer, first of all, plating is carried out over the body portions 30d and 33d on the following conditions:

Plating bath (composition: Na₂SnO₃.3H₂O 60 g/l (litter), CuCN 20 g/l, K₂SO₃H 10 g/l, KCN (free) 30 g/l, KOH 60 g/l, Zn(CN)₂ 5 g/l),

Bath temperature 50° C.,

Current density 2.4 A/dm²,

pH 12.5,

Deposition speed 0.33 μm/min, and

Time 6 minutes.

Consequently, a substrate plated layer of a Cu—Sn—Zn alloy having a thickness of approximately 2 μm is formed on the surfaces of the body portions 30d and 33d.

Next, the plating is carried out over the substrate plated layer on the following conditions, thereby forming an Sn—Cu—Pd alloy plated layer.

Plating Bath:

(composition: Na₂SnO₃.3H₂O 60 g/l (an Sn converted amount 26.7 g/l), CuCN 20 g/l (a Cu converted amount 14.2 g/l), K₂SO₃H 10 g/l, KCN (free) 30 g/l, KOH 60 g/l, K₂Pd(CN)₄.3H₂O 30 g/l (a Pd converted amount 9.3 g/l)),

Plating condition:

Bath temperature 50 to 55° C.,

Current density 2.0 A/dm²,

Current efficiency 47.8%,

pH 12.5 to 13,

Deposition speed 0.33 μm/min, and

Time 9 minutes.

By the plating, an Sn—Cu—Pd alloy plated layer having a thickness of approximately 3 μm, a hardness (Hv) of approximately 300 and a density of 9.6 g/cm³ is formed on the substrate plated layer.

The composition of the plated layer was subjected to a simplified determination by means of a scanning electron microscope and an X-ray microanalyzer. Consequently, there was confirmed a ternary alloy of Sn: 17.12% by weight, Cu: 44.22% by weight and Pd: 38.66% by weight.

Then, the plating is carried out over the Sn—Cu—Pd alloy plated layer on the following conditions so that a finishing plated layer is formed.

Plating Bath

(“PALLABRIGHT—SSS” (trade name) manufactured by JAPAN PURE CHEMICAL CO., LTD.).

Plating Condition:

Bath temperature 55° C.,

Current density 5 A/dm²,

pH 7.6,

Deposition speed 0.33 μm/min, and

Time 6 minutes.

By the plating, a Pd plated layer which is white and glossy is formed in a thickness of approximately 2 μm so that the plated layers 30e and 33e are finished.

Even if a corrosion resistance test for immersing the watch case body 30 and the back cover 33 which are provided with the plated layers 30e and 33e as described above for 24 hours in an artificial sweat (a temperature of 40° C.) comprising the following compositions, the surface is not discolored but has an excellent corrosion resistance:

Sodium chloride 9.9 g/l,

Sodium sulfate 0.8 g/l,

Urea 7.1 g/l,

Aqueous ammonia 0.19 ml/l,

Saccharose 0.2 g/l, and

Lactic acid (50%) 0.8 ml/l.

Even if a heating test for leaving the watch case body 30 and the back cover 33 for five hours at a temperature of 200° C. is carried out, moreover, the peeling of the plated layers 30e and 33e is not recognized at all but a heat resistance can also be enhanced.

The watch case body 30 accommodates a movement 34 including the radio controlled watch receiver, the CPU, the display driving portion and the like which are shown in FIG. 26 described above.

A dial plate 35 and a hand 36 which serve as time display portions are provided above the movement 34 in the drawing. The movement 34 is positioned by the abutment of the dial plate 35 on the lower surface of an inner protruded portion 30b forming the shoulder portion 30a of the watch case 30 in the drawing, and is interposed between the dial plate 35 and a resin middle frame 45 provided on the upper surface of the rising portion 33a of the back cover 33 and is thus fixed.

Moreover, a predetermined space is provided between the movement 34 and the back cover 33, and an antenna 37 is provided in the space. The antenna 37 is constituted by a bar-shaped magnetic core member 38 formed by a ferrite material or the like and a coil 40 wound around the magnetic core member 38, and is fixed to the lower surface of the movement 34.

In the radio controlled watch having the structure described above, the CPU in the movement 34 operates the display driving portion, thereby driving to always correct the hand 36 based on a standard electric wave received by the antenna 37. At this time, the watch case body 30 and the back cover 33 are formed by the non-magnetic members in the watch case according to the present example. Therefore, the disturbance of a resonant phenomenon in the vicinity of the antenna can be reduced so that a receiving sensitivity can be enhanced.

As described above, moreover, the watch case body 30 and the back cover 33 are subjected to the surface finishing. Therefore, there are provided a corrosion resistance and a heat resistance which are necessary for use as a watch case, and furthermore, a white based metal gloss having a massive sense and a sense of high grade. Consequently, the quality of an appearance can also be enhanced.

### EXAMPLE 4

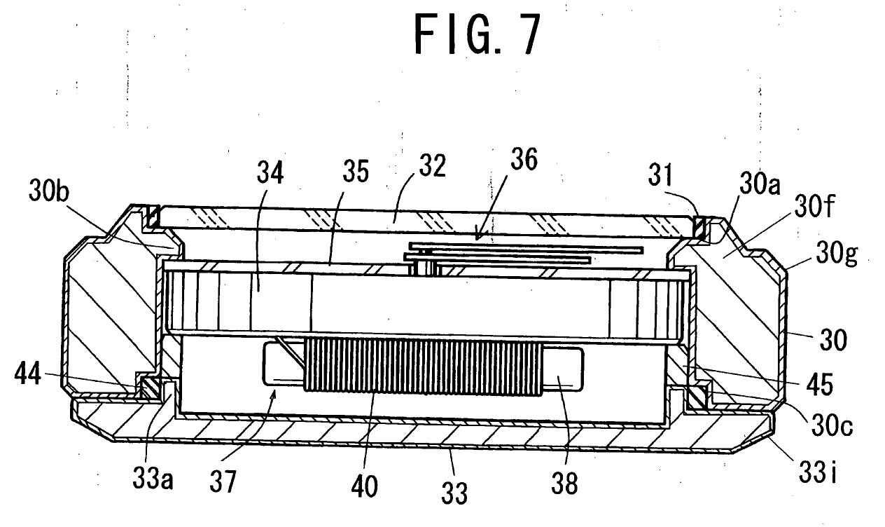

FIG. 7 is a sectional view showing a radio controlled watch case according to another example of the present invention.

A structure according to the present example is the same as that of the example 3 described above, and the materials and surface finishing of a watch case body 30 and a back cover 33 are different from each other. For this reason, the material and the surface finishing will be described in detail.

The watch case body 30 according to the present example is formed by a body portion 30f constituted by a tungsten carbide material (a hard material) and is subjected to mirror finishing, and a plated layer 30g is then formed on a surface by dry plating and is thus finished.

On the other hand, the back cover 33 is formed by a brass material to be a non-magnetic member having an electric resistivity of 7.0 μΩ-Cm or less and is subjected to the mirror finishing, and the substrate plated layer of the Cu—Sn—Zn alloy and the Sn—Cu—Pd alloy plated layer which have been described in the example 3 are formed by wet plating, and a plated layer 33i (which is the same as a plated layer formed on the watch case body 30) is formed on the surface by dry plating and is thus finished.

The plated layers 30g and 33i are formed by carrying out the plating in the following process.

First of all, the substrate plated layer of the Cu—Sn—Zn alloy is formed on the surface of the back cover 33 and the Sn—Cu—Pd alloy plated layer is formed on a surface thereof, through the plating bath and conditions described in the example 3.

Next, the back cover 33 and the body portion 30f formed of tungsten carbide are degreased, cleaned and dried. Subsequently, the body portion 30f and the back cover 33 are set into an ion plating device, and the inside of the device is exhausted and an argon gas is then introduced to set a degree of vacuum in the device to be 1.0×10⁻² Torr.

A thermoelectron filament and a plasma electrode which are provided in the device are operated to generate an argon plasma, thereby washing a surface with an ion bombard for 10 minutes.

Subsequently, a nitrogen gas is introduced into the device and the degree of vacuum in the device is maintained to be 2.0×10⁻³ Torr, and a plasma is generated by the plasma gun of the device and Ti is simultaneously evaporated for five minutes, and a TiN layer having a thickness of 0.25 μm is thus formed on the surfaces of the watch case body 30 and the back cover 33.

Furthermore, the evaporation of Ti and the introduction of the nitrogen gas are stopped, and an Au—Ti alloy containing Ti in 50 atomic % is then evaporated to form an Au—Ti alloy plated layer having a thickness of 0.3 μm on the TiN layer, thereby finishing the plated layers 30g and 33i.

The watch case body 30 and the back cover 33 which are provided with the plated layers 30g and 33i described above have a gold color and a glossiness, and a uniform specified gold color tone to satisfy a IN-14 color on a Swiss gold plating color standard can be exhibited as a color tone thereof.

The color tone measured actually by a color difference meter was L′ 80, a′ 1.0, and b′ 15.0. The plated layers 30g and 33i thus formed were constituted by 88 atomic % of gold, 6.5 atomic % of titanium, 0.5 atomic % of nitrogen, 2 atomic % of oxygen and 3 atomic % of carbon as a result of an analysis by an X-ray photoelectron spectroscopy method.

Referring to the watch case body 30 and the back cover 33, moreover, a corrosion and a discoloration were not recognized at all even if a corrosion resistance test for 24 hours was carried out by using the same artificial sweat as that in the example 3.

In the watch case according to the present example, even if the watch case body 30 is formed of tungsten carbide, the back cover 33 is formed by a non-magnetic member. Therefore, the disturbance of a resonant phenomenon in the vicinity of an antenna is reduced so that a receiving sensitivity is enhanced.

As described above, moreover, the plated layer is formed on the watch case body 30 and the back cover 33, and is subjected to the surface finishing. Consequently, there is provided a necessary corrosion resistance for use as the watch case or the like. In addition, there is a gold color tone having a sense of high grade. Therefore, the quality of an appearance can also be enhanced.

In some cases in which the tungsten carbide is used for the watch case body 30 as in the present example, the surface is simply subjected to the mirror finishing and can be thus used as the watch case even if the dry plating is not carried out.

### EXAMPLE 6

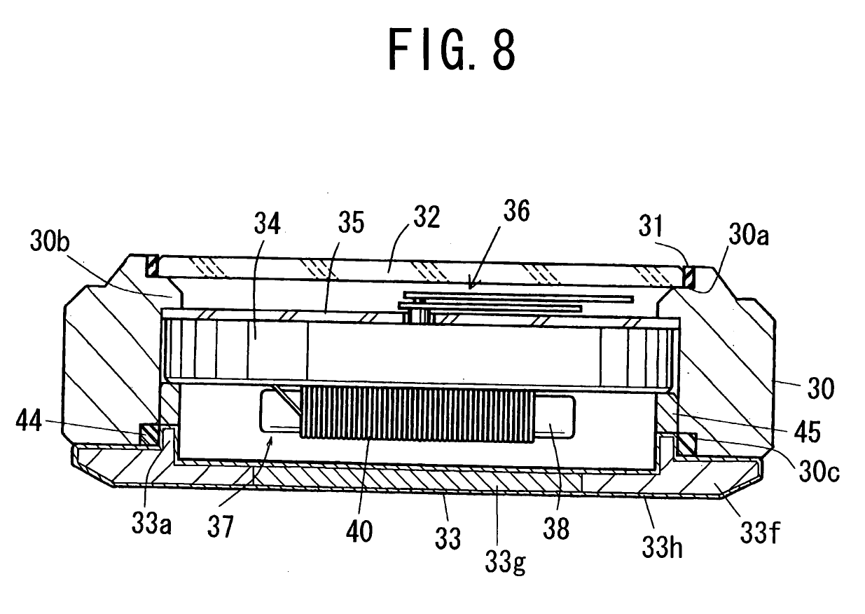

FIG. 8 is a sectional view showing a radio controlled watch case according to another example of the present invention.

A structure according to the present example is also the same as that of the example 3 described above, and the materials and surface finishing of a watch case body 30 and a back cover 33 are different from each other. For this reason, the material and the surface finishing will be described in detail.

The watch case body 30 according to the present example is wholly formed by a stainless material (an austenite type), and hairline patterning finishing is carried out over a surface.

On the other hand, in the back cover 33, a body portion 33f is formed by a stainless material (the austenite type) and a filling member 33g buried and soldered in an opening portion provided on the body portion 33f is formed by a brass material to be a non-magnetic member having an electric resistivity of 7.0 μΩ-Cm or less. Furthermore, a plated layer 33h is then formed on a surface by wet plating and dry plating and is thus finished.

The plated layer 33h is formed by carrying out the plating in the following process.

First of all, the wet plating is carried out on the same conditions as those in the example 3 described above, and a Cu—Sn—Zn alloy plated layer, an Sn—Cu—Pd alloy plated layer and a Pd plated layer are sequentially formed on the surface of the filling member 33g constituted by the brass material.

Next, the body portion 33f formed by a stainless material is washed with an organic solvent together with the filling member 33g provided with the plated layer, and is disposed in an ion plating device.

Subsequently, the inside of the device is exhausted to 1.0×10⁻⁵ Torr and an argon gas is then introduced to 3×10⁻³ Torr. Then, a thermoelectron filament and a plasma electrode which are provided in the device are driven to form an argon plasma.

At the same time, an electric potential of −50 V is applied to the back cover 33 to carry out bombard cleaning for 10 minutes. Thereafter, the introduction of an argon gas is stopped, a nitrogen gas is introduced into the device to 1.0×10⁻³ Torr, a plasma is generated by means of a plasma gun provided in the device, and Ti is then evaporated for 10 minutes. As a result, a coated film formed of a Ti nitride having a degree of nitriding of 0.2 is formed in a thickness of 0.5 μm on the surface of the back cover 33 and the inside of the device is exhausted to 1.0×10⁻⁵ Torr.

Next, an argon gas is introduced into the device to 1.0×10⁻³ Torr, thereby generating a plasma, and a gold-cobalt mixture having 55 atomic % of gold and 45 atomic % of cobalt is then evaporated, and the evaporation of the gold-cobalt mixture is stopped when the thickness of a gold-cobalt alloy film which is deposited reaches 0.3 μm.

The plated layer 33h thus formed contains 63 atomic % of gold and 37 atomic % of cobalt as a result of an analysis executed by an X-ray photoelectron spectroscopy method. Furthermore, the back cover 33 provided with the plated layer 33h has a white color tone which is bright and uniform.

In the watch case according to the present example, even if a part of the watch case body 30 and the back cover 33 is formed by the stainless material, the back cover 33 has a portion formed by the non-magnetic member. Consequently, the disturbance of a resonant phenomenon in the vicinity of an antenna is reduced so that a receiving sensitivity is enhanced.

As described above, moreover, the plated layer 33h is formed on the filling member 33g and the body portion 33f in the back cover 33 and the surface finishing is thus carried out. Consequently, there is provided a necessary corrosion resistance for use as the watch case. In addition, there is a white color tone having a sense of high grade. Therefore, the quality of an appearance can also be enhanced.

It is preferable that the opening portion of the body portion 33f of the back cover 33 according to the present example should be formed to be slightly larger than the external shape of an antenna 37.

### EXAMPLE 7

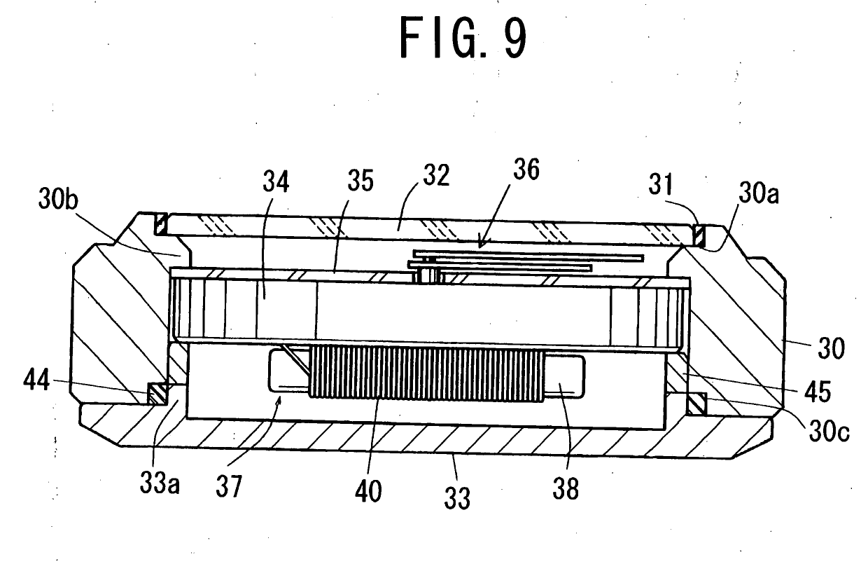

FIG. 9 is a sectional view showing a radio controlled watch case according to another example of the present invention.

A structure according to the present example is also the same as that of the example 3 described above, and the materials and surface finishing of a watch case body 30 and a back cover 33 are different from each other. For this reason, the material and the surface finishing will be described.

The watch case body 30 according to the present example is wholly formed by an 18K gold alloy material (containing silver and copper) to be a non-magnetic member having an electric resistivity of 7.0 μΩ-Cm or less, and a surface is subjected to mirror finishing.

The back cover 33 is wholly formed by a stainless material (an austenite type). In the watch case according to the present example, even if the back cover 33 is formed by the stainless material, the watch case body 30 is formed by the non-magnetic member. Therefore, the disturbance of a resonant phenomenon in the vicinity of an antenna is reduced so that a receiving sensitivity is enhanced.

The watch case according to each of the examples 3 to 7 is constituted by the watch case body 30 and the back cover 33, and it is also possible to use a watch case in which a bezel and a ring are provided in the upper part of the watch case body 30. In this case, if any of a body, a bezel and a back cover is formed by the non-magnetic member, the receiving sensitivity can be enhanced.

Moreover, even if only a part of the body, bezel and the back cover is formed by the non-magnetic member in addition to the formation of the whole of them by the non-magnetic member, the receiving sensitivity can be enhanced. In that case, it is effective that only a portion onto which an antenna 37 is projected in parallel or a relative portion to the end of the antenna 37 is formed by the non-magnetic member, which is preferable.

Furthermore, it is also possible to use a plurality of non-magnetic members in combination in addition to the use of only one kind of non-magnetic member.

### EXAMPLE 8

First of all, an experiment for checking a relationship between a receiving sensitivity and a watch case was executed in the following manner.

2. An Experiment for Checking the Relationship Between the Receiving Sensitivity and the Watch Case:

2-1. Summary of the Experiment:

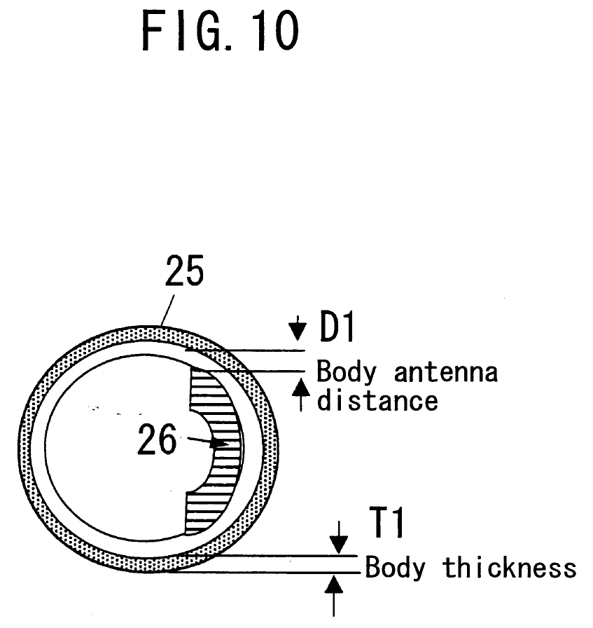

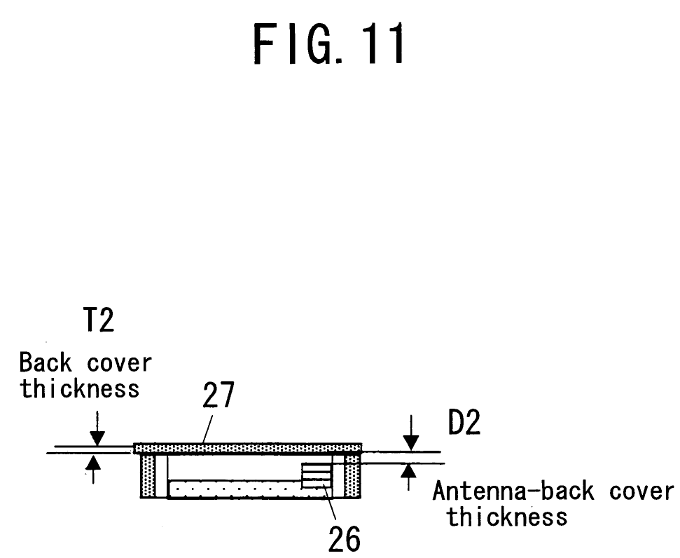

As shown in FIGS. 10 and 11, a body thickness T1 of a watch case body 25, a distance D1 between an antenna 26 and the internal surface of the watch case body 25, a back cover thickness T2 of a back cover 27, and a distance D2 between the antenna 26 and the internal surface of the back cover 27 were selected as parameters.

Relationships between the four parameters and a gain to be the peak height of a signal received by the antenna 26 were obtained from experiments, respectively.

The watch case body 25, the antenna 26 and the back cover 27 in each of experiments which will be described below were identical to those for the experiments which are formed on the assumption that they are used as a watch.

As for the materials of the watch case body 25 and the back cover 27, moreover, stainless steel, titanium, a titanium alloy, gold, silver, copper, brass, aluminum, zinc, magnesium or their alloy, and an alloy containing tungsten carbide and tantalum carbide to be hard metals were selected in consideration of a high workability, a durability, a corrosion resistance, the high quality of the appearance of a product, a price and the like.

In all of the experiments, there was made an error of a gain of several dB. However, a relationship between each of the parameters and the gain (the curved shape of a graph) was rarely changed. Therefore, there are shown numeric values in the use of the stainless steel for the watch case body 25 and the back cover 27 (Particularly, austenite type stainless steel is preferable. For example, SUS304, SUS304L, SUS316, SUS316L and the like) in each of the experiments which will be described below.

2-2. A Relationship Between the Body Thickness T1 and the Receiving Sensitivity:

In this experiment, the gain of a signal received with a change in the body thickness T1 from 0 to 5000 μm was measured.

In this experiment, an antenna for an experiment with 1500 turns of a coil having a conductor diameter of 65 μm was used as an antenna to be provided in the watch case body 25.

Moreover, the distance D1 between the watch case body 25 and the antenna 26 was set to be constant with 1000 μm, and the back cover thickness T2 for the back cover 27 to be used was 800 μm and the distance D2 between the antenna 26 and the back cover 27 was set to be constant with 100 μm. Then, there was executed an experiment for transmitting a signal of 40 kHz from a transmitting antenna provided in a predetermined position.

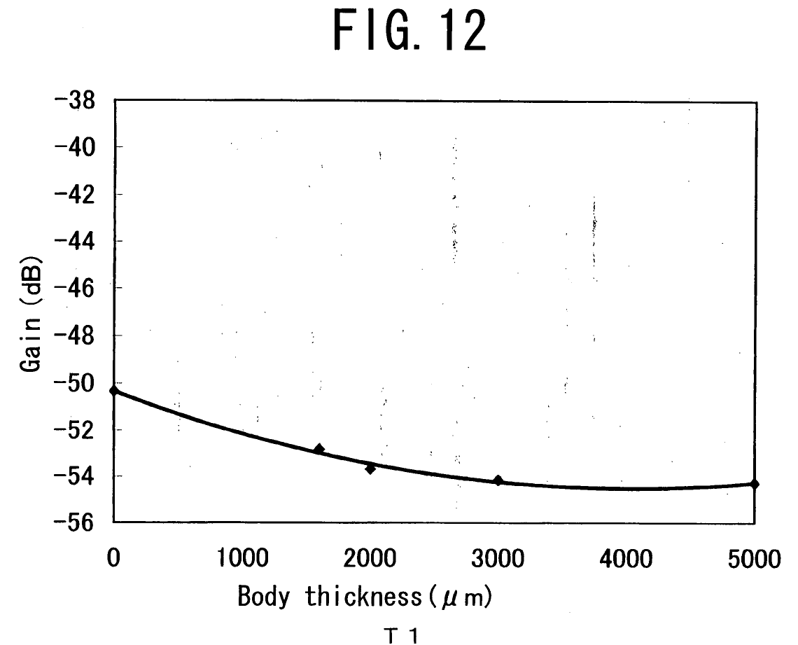

As a result, as shown in FIG. 12, the gain of the received signal is gradually reduced from approximately -50 dB with the body thickness T1 of 0 μm (a state in which the watch case body 25 is not provided) when the body thickness is increased. The reduction is saturated when the body thickness T1 reaches 5000 μm.

A solid line shown in FIG. 12 is an approximation curve obtained from experimental data.

According to the experiment described above, it was found that the reduction in the gain is saturated to be constant when the body thickness T1 exceeds 5000 μm and a value obtained at this time is the smallest. By setting the body thickness T1 to be 0 to 5000 μm, consequently, it is possible to enhance the gain for the smallest value.

In consideration of a strength at which the watch case can be used within the range described above, it is preferable that the body thickness T1 should be set within a range of 300 μm to 5000 μm to be a practical maximum. In order to form an optimum body in consideration of an appearance, a workability, a corrosion resistance and the like for the watch case, moreover, it is preferable that the body thickness T1 should be set within a range of 500 to 2000 μm.

2-3. A Relationship Between the Distance D1 From the Antenna 26 to the Watch Case Body 25 and the Receiving Sensitivity:

In this experiment, there was measured the gain of a signal received with a change in the distance D1 between the antenna 26 and the watch case body 25 from 0 to 40000 μm.

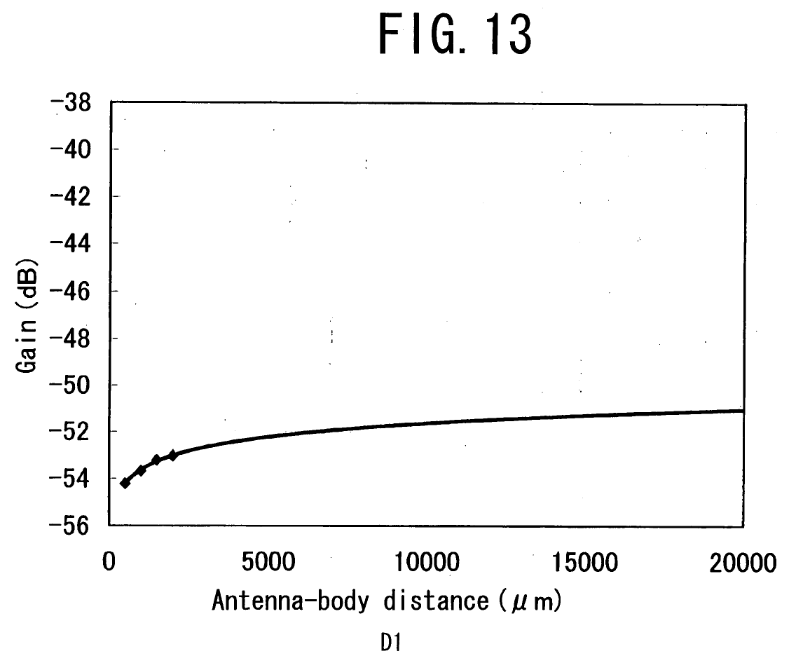

FIG. 13 shows the result of the measurement from 0 to 20000 μm.

In this experiment, an antenna for an experiment with 1500 turns of a coil having a conductor diameter of 65 μm was used as an antenna to be provided in the watch case body 25.

Moreover, the body thickness T1 for the watch case body 25 to be used was 2000 μm, the back cover thickness T2 for the back cover 27 to be used was 800 μm and the distance D2 between the antenna 26 and the back cover 27 was set to be constant, that is, 1001 μm. Then, there was executed an experiment for transmitting a signal of 40 kHz from a transmitting antenna provided in a predetermined position.

As a result, as shown in FIG. 13, the gain of the received signal is gradually increased when the distance D1 is increased from 0 μm with approximately −54.5 dB (a state in which a part of the antenna 26 comes in contact with the watch case body 25).

In this experiment, the gain of the received signal is −50.34 dB in the case of only the back cover 27 (that is, in the case in which the watch case body 25 is removed). At the distance D1 between the antenna 26 and the watch case body 25 which is obtained when the gain has the above same value, therefore, a rise in the gain is saturated.

The distance D1 at which the rise in the gain is thus saturated is 40000 μm, which is not shown in FIG. 13. Even if the antenna 26 and the watch case body 25 are separated from each other at a greater distance, the gain cannot be increased. A solid line shown in FIG. 13 is an approximation curve obtained from experimental data.

According to the experiment described above, it was found that the gain can be increased and the receiving sensitivity can be enhanced if the distance D1 between the antenna 26 and the watch case body 25 is increased, and the rise in the gain is saturated to be constant if the distance D1 exceeds 40000 μm.

If the distance D1 is set to be 0 to 40000 μm, therefore, the gain can be enhanced. In consideration of a size which can be used as the watch case within the range described above, it is preferable that the distance D1 should be set to be 500 to 1000 μm.

2-4. A Relationship Between the Back Cover Thickness T2 and the Receiving Sensitivity:

In this experiment, there was measured the gain of a signal received with a change in the back cover thickness T2 from 0 to 5000 μm.

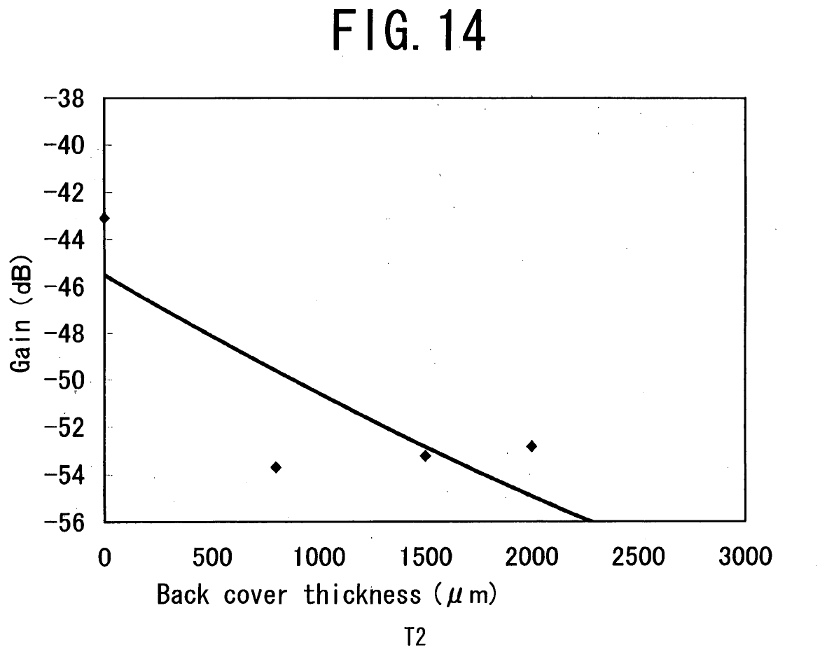

FIG. 14 shows the result of the measurement from 0 to 3000 μm.

In this experiment, an antenna for an experiment with 1500 turns of a coil having a conductor diameter of 65 μm was used as an antenna.

Moreover, the distance D1 between the watch case body 25 and the antenna 26 was set to be constant, that is, 1000 μm, the body thickness T1 for the watch case body 25 to be used was 2000 μm, and the distance D2 between the antenna 26 and the back cover 27 was set to be constant, that is, 100 μm. Then, there was executed an experiment for transmitting a signal of 40 kHz from a transmitting antenna provided in a predetermined position.

As a result, as shown in FIG. 14, it was found that the gain of the received signal is suddenly reduced from approximately -43.4 dB with the back cover thickness T2 of 0 μm (in a state in which the back cover 27 is not provided) to 800 μm, and the gain is not changed greatly with the back cover thickness T2 of 800 μm to 5000 μm. 5000 μm is not shown in FIG. 14.

In other words, it was found that the back cover thickness T2 has the smallest value with 800 μm. A solid line shown in FIG. 14 is an approximation curve obtained from experimental data.

The smallest value is practically allowed, and it is preferable that the back cover thickness T2 should be set within a range of 100 μm to 5000 μm to be a practical maximum in consideration of a strength at which the watch case can be used within the range described above.

In order to form an optimum back cover in consideration of an appearance, a workability, a corrosion resistance and the like for the watch case, moreover, it is preferable that the body thickness T2 should be set within a range of 300 to 2000 μm.

2-5. A Relationship Between the Distance D2 From the Antenna 26 to the Back Cover 27 and the Receiving Sensitivity:

In this experiment, there was measured the gain of a signal received with a change in the distance D2 between the antenna 26 and the back cover 27 from 0 to 5000 μm.

In this experiment, an antenna for an experiment with 2000 turns of a coil having a conductor diameter of 65 μm was used as an antenna to be provided.

Moreover, the body thickness T1 for the watch case body 25 to be used was 2000 μm, the cover thickness T2 for the back cover 27 to be used was 800 μm, and the distance D1 between the watch case body 25 and the antenna 26 was set to be 1000 μm. Then, there was executed an experiment for transmitting a signal of 40 kHz from a transmitting antenna provided in a predetermined position.

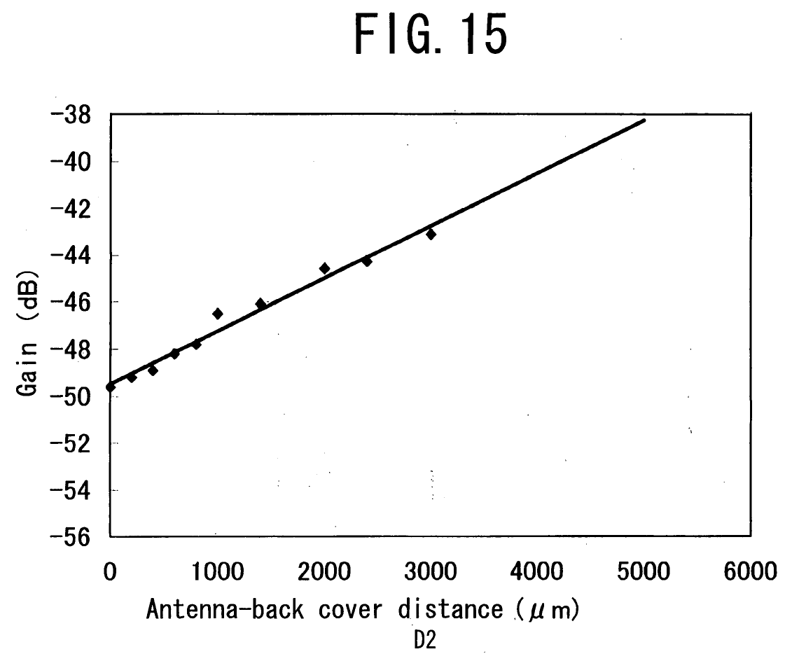

As a result, as shown in FIG. 15, the gain of the received signal is gradually increased when the distance D2 is increased from 0 μm with approximately −49.6 dB (a state in which a part of the antenna 26 comes in contact with the back cover 27).

In this experiment, the gain of the received signal is −38.8 dB in the case of only the watch case body 25 (that is, in the case in which the back cover 27 is removed). At the distance D2 between the antenna 26 and the back cover 27 which is obtained when the gain has substantially the above same value a rise in the gain is saturated.

The distance D2 at which the rise in the gain is thus saturated is 5000 μm. Even if the antenna 26 and the back cover 27 are separated from each other at a greater distance, the gain cannot be increased. A solid line shown in FIG. 15 is an approximation curve obtained from experimental data.

According to the experiment described above, it was found that the gain can be increased and the receiving sensitivity can be enhanced if the distance D2 between the antenna 26 and the back cover 27 is increased. However, the rise in the gain is saturated to be constant if the distance D2 exceeds 5000 μm.

If the distance D2 is set to be 0 to 5000 μm, therefore, the gain can be enhanced. In consideration of a size which can be used as the watch case within the range described above, it is preferable that the distance D2 should be set to be 100 to 700 μm.

Next, description will be given to an example based on the result of the experiment.

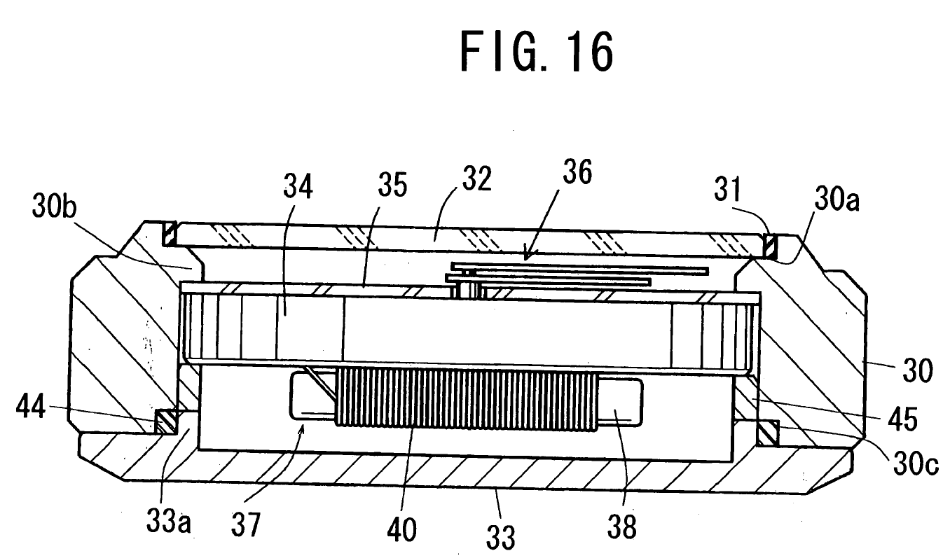

FIG. 16 is a sectional view showing a radio controlled watch according to another example of the present invention.

A watch case body 30 has an substantially cylindrical shape, and a glass 32 is attached through a packing 31 to a shoulder portion 30a provided on the inner peripheral edge of an upper opening portion in the drawing. In addition a back cover 33 is fixed to a lower opening portion in the drawing through means such as press fitting, screwing or a screw.

The back cover 33 shown in FIG. 16 is attached to the watch case body 30 by the press fitting, and a packing 44 is interposed between a rising portion 33a and an inner side surface 30c of the watch case body 30.

Moreover, the watch case body 30 accommodates a movement 34 including the radio controlled watch receiver, the CPU, the display driving portion and the like which are shown in FIG. 26 described above.

A dial plate 35 and a hand 36 which serve as time display portions are provided above the movement 34 in the drawing. The movement 34 is positioned by the abutment of the dial plate 35 on the lower surface of an inner protruded portion 30b forming the shoulder portion 30a of the watch case body 30 in the drawing. As a result, the movement 34 is interposed between the dial plate 35 and a resin middle frame 45 provided on the upper surface of the rising portion 33a of the back cover 33 and is thus fixed.

Furthermore, a predetermined space is provided between the movement 34 and the back cover 33, and an antenna 37 is provided in the space. The antenna 37 is constituted by a bar-shaped magnetic core member 38 and a coil 40 wound around the magnetic core member 38, and is fixed to the lower surface of the movement 34.

In the present example, both the watch case body 30 and the back cover 33 are formed of austenite type stainless steel (for example, SUS316L).

Based on the result of the experiment, moreover, a body thickness T1 of the watch case body 30 is set to be 1600 μm and a distance D1 from the antenna 37 to the internal surface of the watch case body 30 is set to be 2000 μm.

Furthermore, a back cover thickness T2 of the back cover 33 is set to be 800 μm and a distance D2 from the antenna 37 to the internal surface of the back cover 33 is set to be 3000 μm.

In the radio controlled watch having the structure described above, based on a standard radio wave received by the antenna 37, the CPU in the movement 34 operates the display driving portion, thereby driving to always correct the hand 36.

At this time, in the present example, the watch case body 30.and the back cover 33 are formed of a metal such as stainless having a low receiving sensitivity as described in the example 1. Furthermore, the body thickness, the back cover thickness, and the distance between the antenna and the body and back cover are set to have the values based on the result of the experiment which can set the best receiving sensitivity, respectively. Consequently, the disturbance of a resonant phenomenon in the vicinity of the antenna can be reduced so that the receiving sensitivity can be enhanced.

It has been confirmed, from the experiment in the example 1, that a gain can be enhanced by approximately 2 to 3 dB, if a non-magnetic member having an electric resistivity of 7.0 μΩ-Cm or less, for example, gold, silver, copper, brass, aluminum, zinc, magnesium or their alloy is attached to the internal surface of the back cover 33 or the internal surface of the watch case body 30.

Moreover, it is also possible to carry out a hardening treatment such as a carburizing treatment over either the watch case body 30 or the back cover 33 or both of them. A reduction in the receiving sensitivity which is caused by the execution of the hardening treatment was not recognized.

### EXAMPLE 9

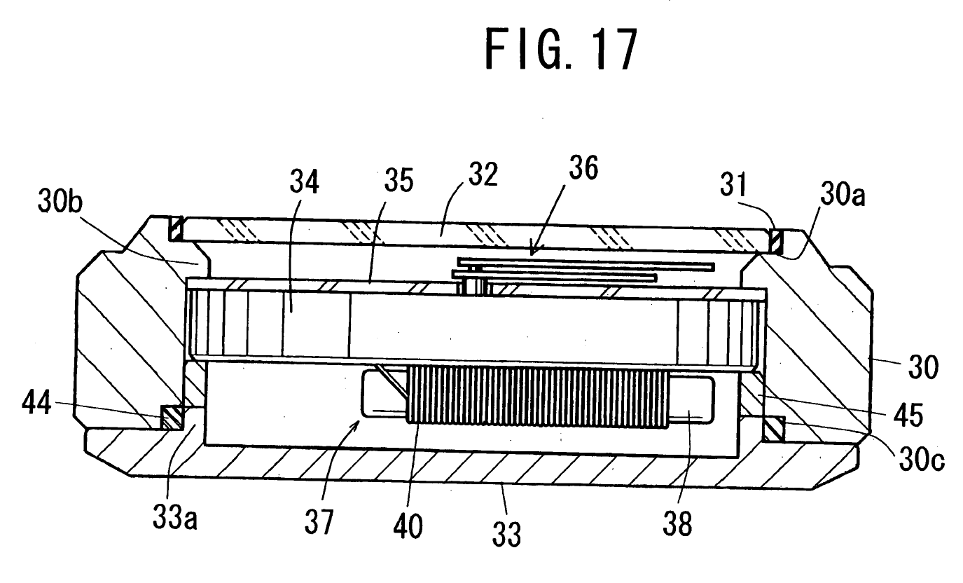

FIG. 17 is a sectional view showing a radio controlled watch according to another example of the present invention.

In the present example, a basic structure related to the shapes of a watch case body 30 and a back cover 33 and the like is the same as that of the example 8. Moreover, the materials of the watch case body 30 and the back cover 33, a body thickness T1 of the watch case body 30, a distance D1 between an antenna 37 and the watch case body 30, a back cover thickness T2 of the back cover 33, and a distance D2 between the antenna 37 and the back cover 33 are different. For this reason, these will be described in detail.

The watch case body 30 and the back cover 33 according to the present example are formed of titanium. In the case of the watch case body 30 and the back cover 33 which are formed of titanium, the body thickness T1 is set to be 2000 μm which is thicker than that in the example 8 on the assumption of a standard corresponding to a high pressure waterproofness, and similarly, the back cover thickness T2 is also set to be 100 μm.

Based on the relationship between the materials of the watch case body 30 and the back cover 33, moreover, even if a distance between the antenna 37 and the watch case body 30 and back cover 33 is decreased, it is possible to obtain an allowable receiving sensitivity. Therefore, the distance D1 between the antenna 37 and the watch case body 30 is set to be 500 μΩm and the distance D2 between the antenna 37 and the back cover 33 is set to be 400 μm.

Also in the present example, the watch case body 30 and the back cover 33 are formed of the metal such as titanium having a low receiving sensitivity as described in the example 1. However, the body thickness, the back cover thickness, and the distance between the antenna and the body and back cover are set to have the values based on the result of the experiment which can obtain the best receiving sensitivity respectively. Consequently, the disturbance of a resonant phenomenon in the vicinity of the antenna can be reduced so that the receiving sensitivity can be enhanced.

Also in the present example, the same non-magnetic member as that in the example 8 described above is attached to the internal surface of the back cover 33 or the internal surface of the watch case body 30. Consequently, it is possible to enhance a gain by approximately 2 to 3 dB.

Moreover, it is also possible to carry out a hardening treatment such as a nitriding treatment over either the watch case body 30 or the back cover 33 or both of them. A reduction in the receiving sensitivity which is caused by the execution of the hardening treatment is not recognized.

### EXAMPLE 10

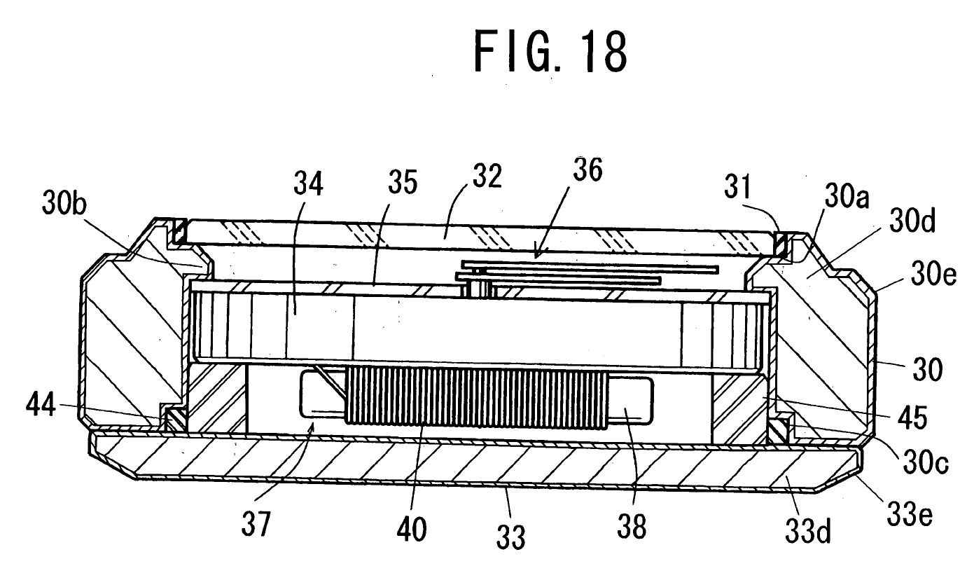

FIG. 18 is a sectional view showing a radio controlled watch according to another example of the present invention.

In the present example, a basic structure related to the shapes of a watch case body 30 and a back cover 33 and the like is substantially the same as that of each of the examples 8 and 9, and the materials of the watch case body 30 and the back cover 33 are different. For this reason, these will be described in detail.

The watch case body 30 and the back cover 33 according to the present example are formed by body portions 30d and 33d constituted by a brass material and mirror finishing is carried out, and plated layers 30e and 33e such as Pd are then formed on surfaces by wet plating and are thus finished.

The brass material is a non-magnetic member having an electric resistivity of 7.0 μΩQ-cm or less which brings the receiving sensitivity confirmed in the experiment according to the example 1 into an excellent state, and can set a body thickness and the like, and furthermore, can enhance the receiving sensitivity more greatly.

The watch case body 30 and the back cover 33 according to the present example are the same as those of the example 8 except that the plating is carried out. Furthermore, a body thickness T1 is set to be 1600 μm and a back cover thickness T2 is set to be 800 μm.

Referring to a distance between the antenna 37 and the watch case body 30 and back cover 33, moreover, a distance D1 between the antenna 37 and the watch case body 30 is set to be 2000 μm and a distance D2 between the antenna 37 and the back cover 33 is set to be 3000 μm.

The plated layers 30e and 33e of the watch case body 30 and the back cover 33 are formed by wet plating which will be described below.

In order to form a substrate plated layer, first of all, plating is carried out over the body portions 30d and 33d on the following conditions:

Plating bath:

(composition: Na₂SnO₃.3H₂O 60 g/l (litter), CuCN 20 g/l, K₂SO₃H 10 g/l, KCN (free) 30 g/l, KOH 60 g/l, Zn(CN)₂ 5 g/l),

Bath temperature 50° C.,

Current density 2.4 A/dm²,

pH 12.5,

Deposition speed 0.33 μm/min, and

Time 6 minutes.

Consequently, a substrate plated layer of a Cu—Sn—Zn alloy having a thickness of approximately 2 μm is formed on the surfaces of the body portions 30d and 33d.

Next, the plating is carried out over the substrate plated layer on the following conditions, thereby forming an Sn—Cu—Pd alloy plated layer.

Plating Bath:

(composition: Na₂SnO₃.3H₂O 60 g/l (an Sn converted amount 26.7 g/l), CuCN 20 g/l (a Cu converted amount 14.2 g/l), K₂SO₃H 10 g/l, KCN (free) 30 g/l, KOH 60 g/l, K₂Pd(CN)₄.3H₂O 30 g/l (a Pd converted amount 9.3 g/l)).

Plating Condition:

Bath temperature 50 to 55° C.,

Current density 2.0 A/dm²,

Current efficiency 47.8%,

pH 12.5 to 13,

Deposition speed 0.33 μm/min, and

Time 9 minutes.

By the plating, an Sn—Cu—Pd alloy plated layer having a thickness of approximately 3 μm, a hardness (Hv) of approximately 300 and a density of 9.6 g/cm³ is formed on the substrate plated layer.

The composition of the plated layer was subjected to a simplified determination by means of a scanning electron microscope and an X-ray microanalyzer. Consequently, there was confirmed a ternary alloy of Sn: 17.12% by weight, Cu 44.22% by weight and Pd: 38.66%.by weight.

Then, the plating is carried out over the Sn—Cu—Pd alloy plated layer on the following conditions so that a finishing plated layer is formed.

Plating Bath

(“PALLABRIGHT—SSS” (trade name) manufactured by JAPAN PURE CHEMICAL CO., LTD.).

Plating Condition:

Bath temperature 55° C.,

Current density 1.5 A/dm²,

pH 7.6,

Deposition speed 0.33 μm/min, and

Time 6 minutes.

By the plating, a Pd plated layer which is white and glossy is formed in a thickness of approximately 2 μm so that the plated layers 30e and 33e are finished.

Even if there is executed a corrosion resistance test for immersing the watch case body 30 and the back cover 33 which are provided with the plated layers 30e and 33e as described above for 24 hours in an artificial sweat (a temperature of 40° C.) comprising the following compositions, the surface is not discolored but has an excellent corrosion resistance:

Sodium chloride 9.9 g/l,

Sodium sulfate 0.8 g/l,

Urea 7.1 g/l,

Aqueous ammonia 0.19 ml/l,

Saccharose 0.2 g/l, and

Lactic acid (50%) 0.8 ml/l.

Even if a heating test for leaving the watch case body 30 and the back cover 33 for five hours at a temperature of 200° C. is carried out, moreover, the peeling of the plated layers 30e and 33e is not recognized at all but a heat resistance can also be enhanced.

Also in the present example, the watch case body 30 and the back cover 33 are formed of a metal. However, the body thickness, the back cover thickness, and the distance between the antenna and the body and back cover are set to have the values based on the result of the experiment which can obtain the best receiving sensitivity respectively. Consequently, the disturbance of a resonant phenomenon in the vicinity of the antenna can be reduced so that the receiving sensitivity can be enhanced.

Moreover, the watch case body 30 and the back cover 33 are subjected to the surface finishing. Therefore, there are provided a corrosion resistance and a heat resistance which are necessary for use as awatch, and furthermore, a white based metal gloss having a sense of massive and high grade. Consequently, the quality of an appearance can also be enhanced.

Also in the examples 8 to 10, if a rising portion is not formed on the back cover 33 as in the back cover 33 shown in FIG. 18 but an internal surface is caused to be flat and the back cover 33 is caused to take a two-dimensional shape on a plane, the disturbance of a resonant phenomenon around the antenna 37 can be more reduced and a receiving sensitivity can be more enhanced by approximately 2 dB as compared with the case in which the rising portion is provided.

In order to further reduce the size and thickness of a watch, moreover, it is also possible to set the distance between the antenna 37 and the watch case body 30 or back cover 33 to be zero in consideration of the directivity of the antenna 37.

In consideration of the directivity of the antenna 37, furthermore, the antenna 37 can be provided in such a manner that the external surface of the antenna 37 and the internal surface of the watch case body 30 or the internal surface of the back cover 33 are parallel with each other or one of the end faces of the antenna 37 can also be provided in an substantially perpendicular direction to the internal surface of the back cover 33 in a vertical rising state.

While the watch case according to each of the examples 8 to 10 is constituted by the watch case body 30 and the back cover 33, moreover, it is also possible to use a watch case in which a bezel or a ring is provided in the upper part of the watch case body 30.

In this case, furthermore, if any of the body, the bezel and the back cover is formed by a non-magnetic member as will be described below, the receiving sensitivity can be more enhanced. By providing the bezel or the like separately from the body, moreover, it is possible to enhance the receiving sensitivity.

Moreover, the receiving sensitivity can be enhanced even if only a part of the body, the bezel and the back cover is formed by the non-magnetic member in addition to the formation of the whole of them by the non-magnetic member. In that case, it is effective that only a portion onto which the antenna 37 is projected in parallel or a relative portion to the end of the antenna 37 is formed by the non-magnetic member, which is preferable.

Furthermore, it is also possible to use a plurality of metals and non-magnetic members in combination in addition to the use of only one kind of metal and non-magnetic member.

As for the selection of materials to be used for the watch case body 30 and the back cover 33, in the same manner as in the experiments described above, an antenna for an experiment is provided in a body and a back cover for an experiment which are formed by the materials to be used, and an experiment for transmitting a signal from a transmitting antenna provided in a predetermined position is carried out.

In the case of gold, silver, copper, brass, aluminum, zinc, magnesium, their alloy or tungsten carbide as a result of the experiment, a gain was increased by 2 to 3 dB (decibel) as compared with the case of stainless steel, titanium, a titanium alloy and tantalum carbide. Moreover, it was also verified, from the same experiment, that not only in the case in which the watch case is formed of a metal having a high receiving sensitivity, but also in the case in which the watch case is formed by a metal having a receiving sensitivity reduced and a metal having a high receiving sensitivity is provided in a part thereof, the receiving sensitivity of the antenna provided on the inside of the watch case can be enhanced.

Furthermore, it has been found that the metal having an electric resistivity of 7 μΩ-Cm or less can maintain a high receiving sensitivity as a result of the comparison of the electric resistivities of the metals used in the experiment. As a result, it has been found that the watch case using the metal can have a receiving sensitivity enhanced if the whole watch case or a part thereof is formed by a non-magnetic member such as gold, silver, copper, brass, aluminum, zinc, magnesium or their alloy and a hard metal.

In addition, it could be verified that the receiving sensitivity can be enhanced if the watch case is formed of a metal having a high electric resistivity such as stainless steel, titanium, a titanium alloy or tantalum carbide which is excellent in the quality of an appearance and a part of them has a portion formed by the non-magnetic member.

Referring to the materials of the body, the back cover and the like, moreover, a resin component is used for a bezel or the like in order to be colorful or a resin decoration is attached to the side surface of a body for ornamental purposes. It is apparent that such a structure using a metal in a basic component is included within the range of the metallic case according to the present invention.

### EXAMPLE 11

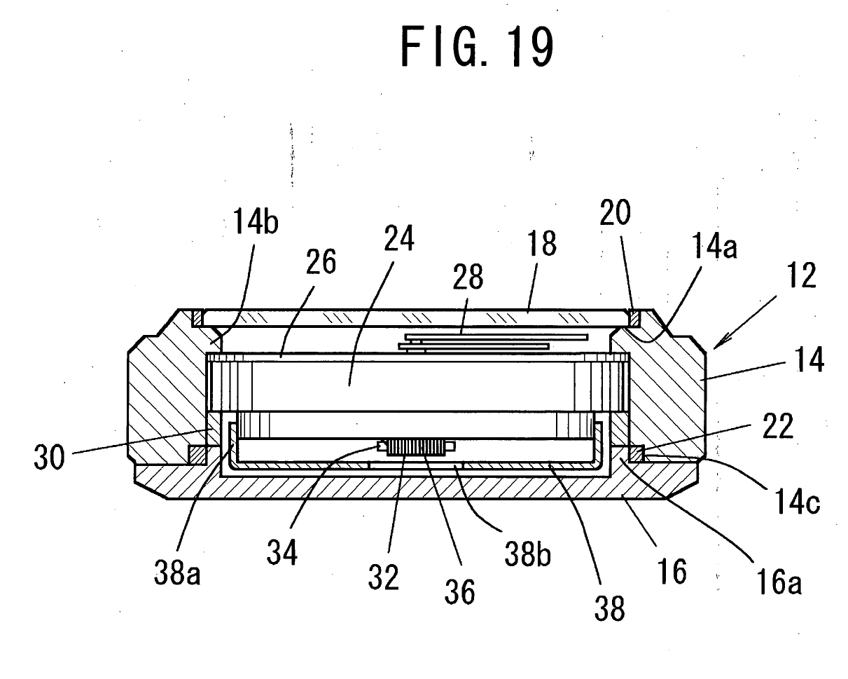

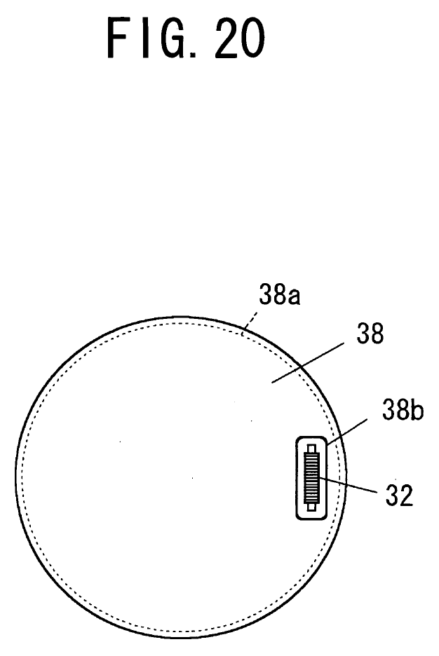

FIG. 19 is a sectional view showing a radio controlled watch according to another example of the present invention, and FIG. 20 is a plan view showing an antimagnetic plate 38 illustrated in FIG. 19 as seen in the direction of a back cover.

A watch case 12 according to the present example is constituted by a watch case body 14, a back cover 16 and a glass 18.

The watch case body 14 has a substantially cylindrical shape, and the glass 18 is attached through a packing 20 to a shoulder portion 14a provided on the inner peripheral edge of an upper opening portion in the drawing. In addition, the back cover 16 is fixed to a lower opening portion in the drawing through means such as press fitting, screwing or a screw.

The back cover 16 shown in FIG. 19 is attached to the watch case body 14 by the press fitting, and a packing 22 is interposed between a rising portion 16a and an inner side surface 14c of the watch case body 14.

Moreover, the watch case body 14 accommodates a movement 24 including a radio controlled watch receiver, a CPU, a display driving portion and the like. A dial plate 26 and a hand 28 which serve as time display portions are provided above the movement 24 in the drawing.

The movement 24 is positioned by the abutment of the dial plate 26 on the lower surface of an inner protruded portion 14b forming the shoulder portion 14a of the watch case body 14 in the drawing, and is interposed between the face 26 and a resin middle frame 30 provided on the upper surface of the rising portion 16a of the back cover 16 and is thus fixed.

Moreover, a predetermined space is provided between the movement 24 and the back cover 16, and an antenna 32 is provided in the space.

The antenna 32 is constituted by a bar-shaped magnetic core member 34 formed by a ferrite material and a coil 36 wound around the magnetic core member 34, and is fixed to the lower surface of the movement 24.

In the present example, moreover, the antimagnetic plate 38 is provided in the space between the movement 24 and the back cover 16.

The antimagnetic plate 38 is formed of ferrite type stainless steel (for example, SUS430), and has a planar shape which is circular to approximate to the planar shape of the movement 24 and has a sectional shape which is upward U-shaped, and has a rising portion 38a in an outer peripheral portion as shown in a plan view seen in the direction of the back cover in FIG. 20.

In the antimagnetic plate 38 according to the present example, the tip part of the rising portion 38a is fixed to the movement 24 through chamfer or a screw.

Moreover, the antimagnetic plate 38 is provided with an opening portion 38b. The opening portion 38b is provided to be positioned in an opposed portion (a relative portion) to the antenna 32 when the antimagnetic plate 38 is attached to the movement 24.

In the present example, the antenna 32 is provided on the corner of the lower surface of the movement 24 in such a manner that the axis of the magnetic core member 34 is turned in an orthogonal direction to the double-sided direction of a watch.

For this reason, the opening portion 38b of the antimagnetic plate 38 is provided in a portion in which the antenna is projected onto the antimagnetic plate 38 in parallel with a plane of the antenna 32 which includes the axis of the magnetic core member 34. Moreover, the inner dimension of the opening portion 38b is set to be equal to or slightly greater than the outer dimension of the antenna 32.

In the radio controlled watch having the structure described above, the CPU in the movement 24 operates the display driving portion, thereby driving to always correct the hand 28 based on a standard radio wave received by the antenna 32.

At this time, in the present example, the movement 24 is surrounded by the antimagnetic plate 38. Therefore, the driving operation of the hand is not influenced by an external magnetism. Moreover, the antimagnetic plate 38 is provided with the opening portion 38b. Consequently, the antenna 32 is opened in the direction of the back cover 16 so that a radio signal can be received without the shielding of the antimagnetic plate 38.

### EXAMPLE 12

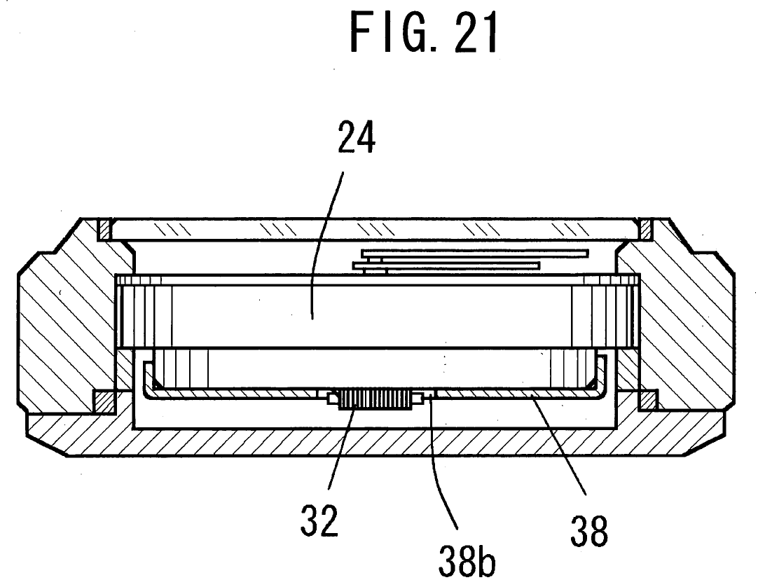

FIG. 21 is a sectional view showing a radio controlled watch according to another example of the present invention.

In the present example, a basic structure related to the structures of a watch case 12, an antimagnetic plate 38 and the like is the same as that of the example 1, and a positional relationship between the antimagnetic plate 38 and an antenna 32 is different from that in the example 11. For this reason, the difference will be described in detail.

In the present example, the antimagnetic plate 38 formed of pure iron is assembled into the lower part of a movement 24 so as to come in contact with the lower surface of the movement 24. At this time, the antenna 32 is protruded in the direction of a back cover 16 from an opening portion 38b of the antimagnetic plate 38 and is positioned on the outside of the antimagnetic plate 38.

Therefore, the antenna 32 is positioned in a place which is not surrounded by the antimagnetic plate 38. Consequently, it is possible to receive a radio signal without the influence of the antimagnetic plate 38.

In the present example, the antimagnetic plate 38 and the movement 24 are provided in contact in many parts. Therefore, it is also possible to bond and fix the antimagnetic plate 38 to the movement 24 with an adhesive.

### EXAMPLE 13

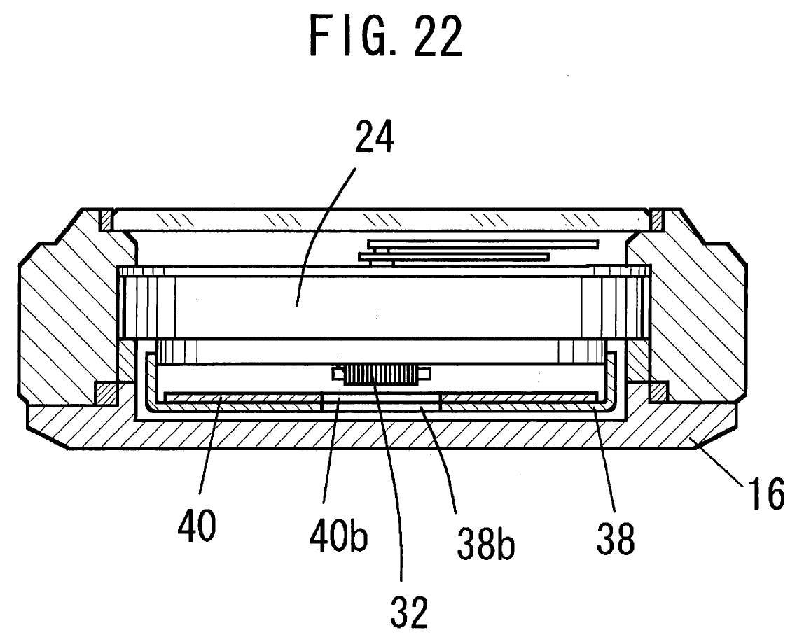

FIG. 22 is a sectional view showing a radio controlled watch according to another example of the present invention.

In the present example, a basic structure such as a positional relationship between a watch case 12 or an antimagnetic plate 38 and an antenna 32 and the like is the same as that of the example 11, and a non-magnetic member 40 is provided differently from the example 11. For this reason, the non-magnetic member 40 will be described in detail.

The non-magnetic member 40 is formed by a metal material having an electric resistivity of 70 μΩ-Cm or less, for example, gold, silver, copper, brass, aluminum, magnesium, zinc or their alloy, and is formed by a plate-shaped copper material in the present example.

Moreover, the antimagnetic plate 38 is formed by a YUS material (a clad material) and is positioned between a movement 24 and a back cover 16 in the same manner as in the example 11. In addition, an antenna 32 is provided to be positioned on the movement 24 side from the antimagnetic plate 38.

The non-magnetic member 40 is provided between the antimagnetic plate 38 and the antenna 32 as described above, and is attached onto the internal surface of the antimagnetic plate 38 which faces the antenna 32 in the present example.

Thus, the non-magnetic member 40 is provided opposite to the antenna 32 or the non-magnetic member 40 is provided in the vicinity of the antenna. Consequently, it has been confirmed from an experiment that the receiving gain of a radio signal is enhanced by approximately 2 to 3 dB.

Moreover, the non-magnetic member 40 according to the present example is provided with an opening portion 40b in a corresponding position to an opening portion 38b of the antimagnetic plate 38. In addition, the non-magnetic member 40 has such a structure as not to block the receipt of a radio signal in the same manner as the antimagnetic plate 38.

In order to prevent a corrosion, moreover, it is possible to carry out a surface treatment such as plating over the non-magnetic member 40. There was not recognized a reduction in a receiving sensitivity which is caused by the execution of the surface treatment.

### EXAMPLE 14

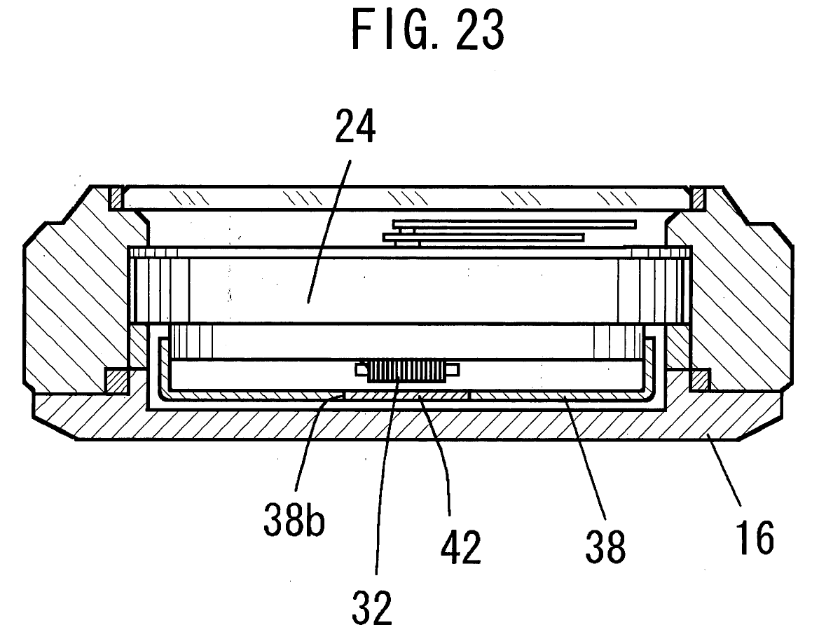

FIG. 23 is a sectional view showing a radio controlled watch according to a further example of the present invention.

In the present example, a basic structure such as a positional relationship between a watch case 12 or an antimagnetic plate 38 and an antenna 32 and the like is the same as that of the example 11. In addition, a non-magnetic member 42 is provided in an opening portion 38b of the antimagnetic plate 38 differently from the example 11. For this reason, the difference will be described in detail.

The non-magnetic member 42 is formed by a metal material having an electric resistivity of 7.0 μΩ-Cm or less which is the same as that of the example 13, and is formed of brass in the present example.

Moreover, the antimagnetic plate 38 according to the present example is formed of ferrite type stainless steel (for example, SUS430). In addition, the antimagnetic plate 38 is provided between a movement 24 and a back cover 16 in the same manner as in the example 11 described above, and has an opening portion 38b in a relative position to the antenna 32 which is attached to the lower surface of the movement 24.

The non-magnetic member 42 is attached into the opening portion 38b of the antimagnetic plate 38 through caulking, soldering, adhesion or the like and is opposed to the antenna 32. When the non-magnetic member 42 is thus provided, the disturbance of a resonant phenomenon in the vicinity of the antenna can be reduced so that a receiving sensitivity can be enhanced. Consequently, the receiving gain of a radio signal can be enhanced by approximately 2 to 3 dB.

Moreover, a surface treatment such as plating can also be carried out over the non-magnetic member 42 in the same manner as the non-magnetic member 40 according to the example 13. In this case, there was not recognized a reduction in the receiving sensitivity which is caused by the execution of the surface treatment.

### EXAMPLE 15

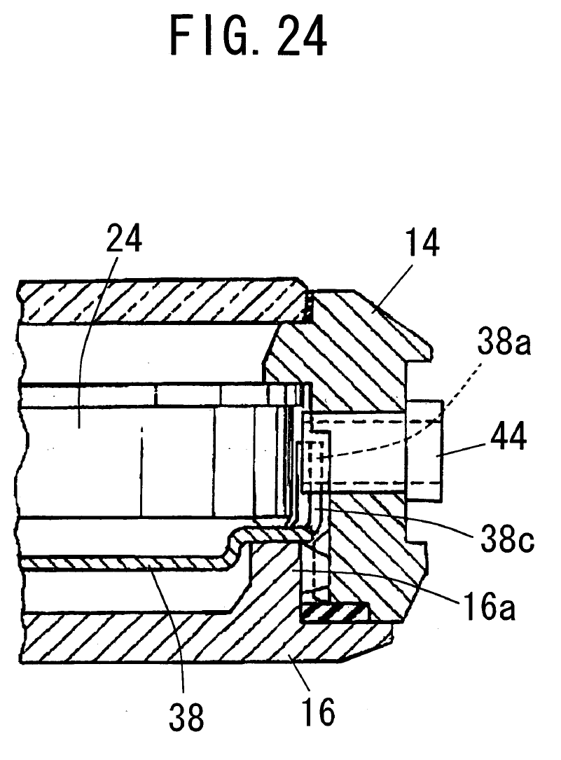

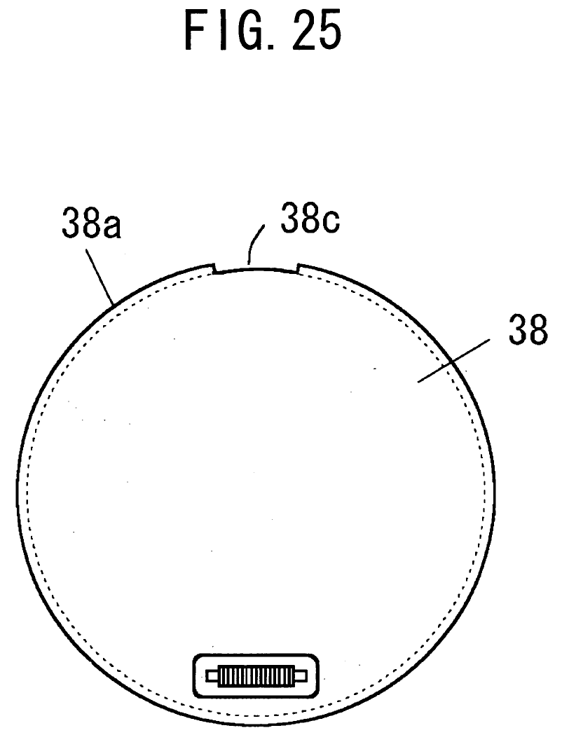

FIG. 24 is a sectional view showing a radio controlled watch according to another example of the present invention, and FIG. 25 is a plan view showing an antimagnetic plate 38 illustrated in FIG. 24 as seen in the direction of a back cover.

In the present example, a basic structure such as a positional relationship between a watch case 12 or the antimagnetic plate 38 and an antenna 32 and the like is the same as that of the example 1. In addition, a detent is provided on the antimagnetic plate 38 and the fixation of the antimagnetic plate 38 is carried out by an interposition between the upper surface of a rising portion 16a of a back cover 16 of a screw type and the lower surface of a movement 24 differently from the example 11. For this reason, the difference will be described in detail.

The antimagnetic plate 38 is provided with a rising portion 38a erected to surround the movement 24.

In the present example, a notch portion 38c is provided on a part of the rising portion 38a. Moreover, the notch portion 38c is fitted in the inner end of a side pipe 44 penetrating through a watch case body 14, thereby stopping the rotation of the antimagnetic plate 38 to easily carry out positioning.

Since the back cover 16 is fixed to the watch case body 14 with a screw, moreover, it is supposed that the antimagnetic plate 38 provided on the upper surface of the rising portion 16a of the back cover 16 is also rotated. Since the side pipe 44 is fitted in the notch portion 38c described above, the rotation of the antimagnetic plate 38 can also be hindered.

It is also possible to use any of the materials of the watch case 12 constituted by the watch case body 14, the back cover 16 and the like according to each of the examples 11 to 15 which is suitable for a radio controlled watch, for example, stainless, plastic and the like.

In each of the examples 11 to 15, moreover, the antenna 32 is provided on the corner of the lower surface of the movement 24 in such a manner that the axis of a magnetic core member 34 is turned in an orthogonal direction to the double-sided direction of a watch.

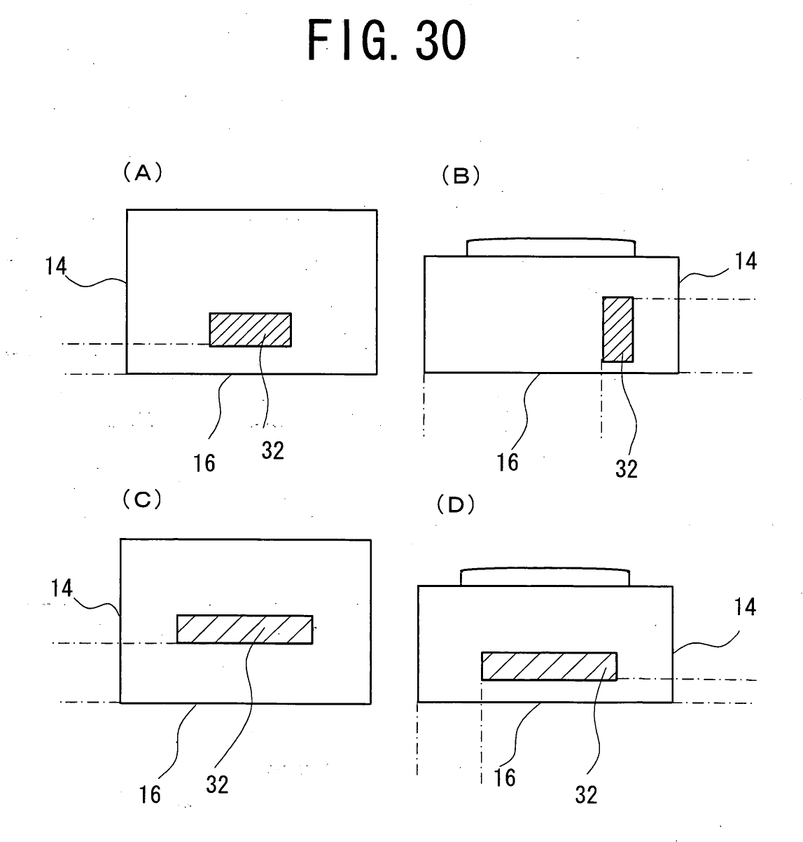

In the case in which the watch case is seen in a longitudinal section in consideration of the directivity of the antenna 32, however, it is also possible to dispose one of the end faces of both ends in the axial direction of the antenna 32 in substantially parallel with the internal surface of the back cover 16 of the watch case (see FIG. 30(B)). Furthermore, it is also possible to dispose the external side surface of the antenna 32 substantially perpendicularly to the internal surface of the back cover 16 of the watch case (see FIG. 30(B)) to provide the antenna 32 in a longitudinal erecting state (in a vertical direction).

Furthermore, in the case in which the watch case body 14 has a rectangular shape seen on a plane, for example, it is also possible to dispose the internal surface of the watch case body 14 of the watch case and the external side surface of the antenna 32 (that is, an external side surface in the transverse direction of the antenna) in substantially parallel with each other as seen on a plane, thereby providing the antenna 32 in a longitudinal erecting state (in a vertical direction) (see FIG. 30(A)).

In the case in which the watch case is seen in a longitudinal section in consideration of the directivity of the antenna 32, moreover, it is also possible to dispose one of the end faces of both ends in the axial direction of the antenna 32 substantially perpendicularly to the internal surface of the back cover 16 of the watch case (see FIG. 30(D)). Furthermore, it is also possible to dispose the internal surface of the watch case body 14 of the watch case and the external side surface of the antenna 32 in substantially parallel as seen on a plane (see FIG. 30(C)) to provide the antenna 32 in an overlying state in a horizontal direction.

Moreover, in the case in which the watch case body 14 has a rectangular shape seen on a plane, for example, it is also possible to dispose the internal surface of the back cover 16 of the watch case and the external side surface of the antenna 32 (that is, an external side surface in the longitudinal direction of the antenna) in substantially parallel with each other (see FIG. 30(D)), thereby providing the antenna 32 in an overlying state in a horizontal direction.

In this case, an opening portion 38b of the antimagnetic plate 38 may be formed relative to the whole shape of the antenna 32 as in each of the examples 11 to 15 described above or may be formed on the rising portion 38a so as to be opposed to the end of the antenna 32, for example.

Moreover, it is also possible to use a plurality of metals and non-magnetic members in combination in addition to the use of only one kind of material to be utilized for the antimagnetic plate 38 and the non-magnetic members 40 and 42.

Referring to the selection of the material to be used for the non-magnetic members 40 and 42, a non-magnetic member formed by a material to be used and an antenna for an experiment were provided in a case for an experiment and an experiment for transmitting a signal from a transmitting antenna provided in a predetermined position was carried out to perform the selection (see the experiment according to the example 1).

As a result of the experiment, in the case of gold, silver, copper, brass, aluminum, magnesium, zinc or their alloy, a gain was higher by 2 to 3 dB (decibel) as compared with the case of titanium, a titanium alloy, stainless steel and tantalum carbide.

Moreover, it is apparent that a metal having an electric resistivity of 7 μΩ-Cm or less can maintain a high receiving sensitivity as a result of the comparison of the electric resistivities of the metals used in the experiment (see the experiment according to example 1).

As a result, it is apparent that the receiving sensitivity can be enhanced also when the antimagnetic plate 38 is used if the non-magnetic members 40 and 42 are formed by a material such as gold, silver, copper, brass, aluminum, magnesium, zinc or their alloy.

According to each of the examples 11 to 15, the antimagnetic plate is provided in a radio controlled watch so that a watch device can be protected from an external magnetism. Consequently, precision in a time display can be enhanced.

Even if the antimagnetic plate is provided, moreover, a reduction in a radio receiving performance for time information or the like can be remarkably lessened because the opening portion and the non-magnetic member are provided on the antimagnetic plate. Consequently, it is possible to implement a magnetism resistant structure without influencing the original performance of the radio controlled watch.

While the preferred examples of the present invention have been described above, the present invention is not restricted thereto. Although the description has been given to the watch case body, the back cover and the bezel as the watch case in the present invention, the present invention can also be applied to other watches having a watch case such as a ring. Furthermore, the present invention can also applied to not only applied to a radio controlled watch but also applied to a wall-hanging clock, a table clock, an alarm clock and the like. Thus, various changes can be made without departing from the scope of the present invention.

### EFFECT OF THE INVENTION

According to the present invention, the non-magnetic member having the electric resistivity of 7.0 μΩ-Cm or less is provided in the watch case accommodating the antenna and the watch device. Consequently, it is possible to reduce the disturbance of a resonant phenomenon in the vicinity of the antenna which is caused by a metal material. Therefore, it is possible to obtain a sufficient receiving sensitivity also in a metal watch case.

By using the non-magnetic member having the electric resistivity of 7.0 μΩ-Cm or less as a non-magnetic member to be fixed to a watch case in the radio controlled watch, for example, a watch case body and the internal surface of a back cover, consequently, it is possible to use a metal having the high quality of an appearance such as titanium, a titanium alloy, stainless steel or tantalum carbide which has a low receiving sensitivity, a low frequency selectivity and a high electric resistivity as the watch case, for example, the watch case body and the back cover without sacrificing the receiving sensitivity. Thus, it is possible to enhance functions in respect of the mechanism and appearance of the watch case.

According to the present invention, moreover, a part of the watch case, for example, a part of the watch case body, the back cover, the bezel and the like, or at least one of them is formed by the non-magnetic member having the electric resistivity of 7.0 μΩ-Cm or less. Therefore, the disturbance of a resonant phenomenon in the vicinity of the antenna which is caused by the metal material can be reduced by the non-magnetic member. Consequently, it is possible to obtain a sufficient receiving sensitivity also in the metal watch case.

If the non-magnetic member having the electric resistivity of 7.0 μΩ-Cm or less is used for a part of the watch case, for example, a part of the watch case body, the back cover, the bezel and the like, or at least one of them in the radio controlled watch, consequently, it is possible to use a metal having the high quality of an appearance such as titanium, a titanium alloy, stainless steel or tantalum carbide which has a low receiving sensitivity, a low frequency selectivity and a high electric resistivity as a watch case portion other than the watch case portion formed by the non-magnetic member without sacrificing the receiving sensitivity. Consequently, it is possible to enhance functions in respect of the mechanism and appearance of the watch case.

In addition, surface finishing is carried out over the surface of the watch case portion formed by the non-magnetic member. Therefore, it is possible to design and manufacture a watch case having a corrosion resistance, a heat resistance, a mechanical strength and the like and having a color tone such as a metal color having a sense of high grade and the high quality of an appearance, for example, a watch case body, a back cover, a bezel and the like in the same manner as in a general watch which is not the radio controlled watch. Thus, the design variation of the case in the radio controlled watch can be increased equivalently to the general watch.

According to the present invention, the watch case is constituted by a metal and a distance between the antenna and the watch case, that is, a body thickness T1 of the watch case body of the watch case, a back cover thickness T2 of the back cover of the watch case, a gap D1 from the internal surface of the watch case body to the antenna, and a gap D2 from the internal surface of the back cover to the antenna are set based on a receiving sensitivity. Consequently, it is possible to reduce the disturbance of a resonant phenomenon in the vicinity of the antenna which is caused by a metal material. Therefore, it is possible to enhance the receiving sensitivity also in the metal watch case. Thus, it is possible to use a metal having the high quality of an appearance such as titanium, a titanium alloy, stainless steel or tantalum carbide which has a low receiving sensitivity, a low frequency selectivity and a high electric resistivity as the watch case, for example, the watch case body, the back cover, the bezel or the like without sacrificing the receiving sensitivity. Consequently, it is possible to enhance functions in respect of the mechanism and appearance of the watch case.

According to the present invention, moreover, the antimagnetic plate provided in the watch case has the opening portion in the opposed part to the antenna. Consequently, the antenna can receive a radio wave through the opening portion without the influence of the antimagnetic plate. Thus, it is possible to protect the watch device from an external magnetism also in the radio controlled watch without deteriorating a radio wave receiving performance. Thus, it is possible to enhance precision in the watch without an influence on the driving operation of a hand.

The watch case for accommodating the antenna is formed by a material having an electrical non-conductivity or a low electric resistivity, and the exterior member attached to the outside of the watch case, particularly, the exterior member for covering the external side surface of the watch case body is electrical conductive, for example, a metal.

As compared with the case in which the watch case itself for accommodating the antenna is formed by a conductive material, accordingly, a distance between the antenna and the electrical conductive exterior member can be increased. Consequently, the receiving fault of the antenna is caused with difficulty. Thus, the antenna can receive a radio wave well so that a receiving performance and precision in the watch can be enhanced.

By the conductive exterior member such as the metal, furthermore, an appearance having a sense of the metal can be given to the radio controlled watch. Consequently, a visual recognition is carried out as if the watch case is formed of a solid metal. Therefore, it is possible to prevent a sense of high grade and a fine appearance from being damaged by using a non-conductive material such as a synthetic resin for the watch case. Thus, the invention can produce many remarkable and peculiar functions and effects, which is very excellent.

1. A radio controlled watch comprising:
an antenna for receiving a radio wave including time information;
a watch device for causing a display portion to display time information such as a present time by the radio wave received by the antenna;
a watch case for accommodating the antenna and the watch device; and
at least one non-magnetic member fixed to an internal surface of the watch case and having an electric resistivity set to be 7.0 μΩ-Cm or less.

2. The radio controlled watch according to claim 1, wherein the watch case is formed by at least one material selected from titanium, a titanium alloy, stainless steel, tungsten carbide and tantalum carbide, and
the non-magnetic member is fixed to an internal surface of the watch case.

3. The radio controlled watch according to claim 1, wherein the watch case includes a watch case body,
the watch case body being formed by at least one material selected from titanium, a titanium alloy, stainless steel, tungsten carbide and tantalum carbide, and
the non-magnetic member is fixed to an internal surface of the watch case body.

4. The radio controlled watch according to claim 1, wherein the watch case includes a watch case body and a back cover attached and fixed to the watch case body,
the back cover being formed by at least one material selected from titanium, a titanium alloy, stainless steel, tungsten carbide and tantalum carbide, and
the non-magnetic member is fixed to an internal surface of the back cover.

5. The radio controlled watch according to an claim 1, wherein the non-magnetic member is formed by at least one material selected from gold, silver, copper, brass, aluminum, magnesium, zinc and their alloy.

6. The radio controlled watch according to claim 1, wherein the non-magnetic member is formed by bonding at least two materials selected from gold, silver, copper, brass, aluminum, magnesium and their alloy.

7. The radio controlled watch according to claim 1, wherein a resin member is provided in close contact with an internal surface of the non-magnetic member.

8. The radio controlled watch according to claim 1, wherein the antenna is constituted by a magnetic core member and a coil wound around the magnetic core member in plural turns, and
the non-magnetic member is provided in a position in which the antenna is projected onto the internal surface of the watch case in parallel along at least one plane including an axis of the magnetic core member.

9. The radio controlled watch according to claim 8, wherein the antenna is constituted by the magnetic core member and the coil wound around the magnetic core member in plural turns, and
the non-magnetic member is provided in a position of the watch case body in which the antenna is projected onto the internal surface of the watch case in parallel along at least one plane including the axis of the magnetic core member.

10. The radio controlled watch according to claim 8, wherein the antenna is constituted by the magnetic core member and the coil wound around the magnetic core member in plural turns, and
the non-magnetic member is provided in a position of the back cover in which the antenna is projected onto the internal surface of the watch case in parallel along at least one plane including the axis of the magnetic core member.

11. The radio controlled watch according to claim 1, wherein the antenna is constituted by a magnetic core member and a coil wound around the magnetic core member in plural turns, and
the non-magnetic member is provided in a position of the internal surface of the watch case which is opposed to at least one end in an axial direction of the antenna.

12. The radio controlled watch according to claim 1, wherein the watch case is constituted by a clad material obtained by bonding the non-magnetic member in pressure contact with at least one material selected from titanium, a titanium alloy and stainless steel.

13. The radio controlled watch according to claim 1, wherein the watch case includes a watch case body,
the watch case body being constituted by a clad material obtained by bonding the non-magnetic member in pressure contact with at least one material selected from titanium, a titanium alloy and stainless steel.

14. The radio controlled watch according to claim 1, wherein the watch case includes a watch case body and a back cover attached and fixed to the watch case body,
the back cover being constituted by a clad material obtained by bonding the non-magnetic member in pressure contact with at least one material selected from titanium, a titanium alloy and stainless steel.

15. The radio controlled watch according to claim 1, wherein the non-magnetic member is fixed to the watch case by at least one means such as press fitting, caulking, welding, soldering and an adhesive.

16. The radio controlled watch according to claim 1, wherein the watch case includes a watch case body, and
the non-magnetic member is fixed to the watch case body by at least one means such as press fitting, caulking, welding, soldering and an adhesive.

17. The radio controlled watch according to claim 1, wherein the watch case includes a watch case body and a back cover attached and fixed to the watch case body, and
the non-magnetic member is fixed to the back cover by at least one means such as press fitting, caulking, welding, soldering and an adhesive.

18. The radio controlled watch according to claim 1, wherein the non-magnetic member fixed to the watch case is formed by means such as a wet plating method or a metal spraying method.

19. The radio controlled watch according to claim 1, wherein the watch case includes a watch case body, and
the non-magnetic member fixed to the watch case body is formed by means such as a wet plating method or a metal spraying method.

20. The radio controlled watch according to claim 1, wherein the watch case includes a watch case body and a back cover attached and fixed to the watch case body, and
the non-magnetic member fixed to the back cover is formed by means such as a wet plating method or a metal spraying method.

21. The radio controlled watch according to claim 1, wherein the non-magnetic member has a thickness of 50 μm to 2000 μm.

22. A radio controlled watch comprising:
an antenna for receiving a radio wave including time information;
a watch device for causing a display portion to display time information such as a present time by the radio wave received by the antenna; and
a watch case for accommodating the antenna and the watch device,
wherein the watch case has at least a part constituted by a non-magnetic member having an electric resistivity of 7.0 μΩ-Cm or less, and
a surface of the watch case is subjected to surface finishing.

23. The radio controlled watch according to claim 22, wherein the watch case includes a watch case body, a back cover and a bezel,
at least one of the watch case body, the back cover and the bezel is constituted by a non-magnetic member, and
the watch case other than the watch case constituted by the non-magnetic member is constituted by at least one material selected from titanium, a titanium alloy, stainless steel, tungsten carbide, tantalum carbide and a resin.

24. The radio controlled watch according to claim 22, wherein the non-magnetic member is constituted by at least one material selected from gold, silver, copper, brass, aluminum, magnesium, zinc and their alloy.

25. The radio controlled watch according to claim 22, wherein the non-magnetic member is formed by bonding at least two materials selected from gold, silver, copper, brass, aluminum, magnesium and their alloy.

26. The radio controlled watch according claim 22, wherein the antenna is constituted by a magnetic core member and a coil wound around the magnetic core member in plural turns, and
a member of the watch case onto which the antenna is projected in parallel along at least one plane including an axis of the magnetic core member or a portion onto which the projected member of the watch case is projected is constituted by the non-magnetic member.

27. The radio controlled watch according to claim 22, wherein the antenna is constituted by a magnetic core member and a coil wound around the magnetic core member in plural turns, and
a member of the watch case opposed to at least one end in an axial direction of the antenna or a portion opposed to the member of the watch case opposed to the end in the axial direction is constituted by the non-magnetic member.

28. The radio controlled watch according to claim 22, wherein the surface finishing is constituted by at least one surface finishing process selected from a mirror finished surface, a mat finished surface, a hairline pattering, a pattern and a letter.

29. The radio controlled watch according to claim 22, wherein the surface finishing is constituted by a metal coated film,
the metal coated film being provided by at least one means selected from a wet plating method, a vapor deposition method, an ion plating method, an arcing method and a sputtering method.

30. The radio controlled watch according to claim 22, wherein a surface of the non-magnetic member is subjected to the surface finishing.

31. A radio controlled watch comprising:
an antenna for receiving a radio wave including time information;
a watch device for causing a display portion to display time information such as a present time by the radio wave received by the antenna; and
a watch case for accommodating the antenna and the watch device,
wherein the watch case is constituted by a metal.

32. The radio controlled watch according to claim 31, wherein the antenna is provided in contact with an internal surface of the watch case.

33. The radio controlled watch according to claim 31, wherein the antenna is provided apart from an internal surface of the watch case.

34. The radio controlled watch according to claim 31, wherein the watch case and the antenna are set in such a manner that a body thickness T1 of a watch case body of the watch case ranges from 300 μm to 5000 μm.

35. The radio controlled watch according to claim 34, wherein the watch case and the antenna are set in such a manner that the body thickness T1 of the watch case body of the watch case ranges from 500 μm to 2000 μm.

36. The radio controlled watch according to claim 31, wherein the watch case and the antenna are set in such a manner that a gap D1 from an internal surface of the watch case body of the watch case to the antenna ranges from 0 to 40000 μm.

37. The radio controlled watch according to claim 36, wherein the watch case and the antenna are set in such a manner that the gap D1 from the internal surface of the watch case body of the watch case to the antenna ranges from 500 μm to 10000 μm.

38. The radio controlled watch according to claim 31, wherein the watch case and the antenna are set in such a manner that a back cover thickness T2 of a back cover of the watch case ranges from 100 μm to 5000 μm.

39. The radio controlled watch according to claim 38, wherein the watch case and the antenna are set in such a manner that the back cover thickness T2 of the back cover of the watch case ranges from 300 μm to 2000 μm.

40. The radio controlled watch according to claim 31, wherein the watch case and the antenna are set in such a manner that a gap D2 from an internal surface of the back cover of the watch case to the antenna ranges from 0 to 5000 μm.

41. The radio controlled watch according to claim 40, wherein the watch case and the antenna are set in such a manner that the gap D2 from the internal surface of the back cover of the watch case to the antenna ranges from 100 μm to 700 μm.

42. The radio controlled watch according to claim 31, wherein the watch case body of the watch case is formed by at least one material selected from titanium, a titanium alloy, stainless steel, tungsten carbide and tantalum carbide.

43. The radio controlled watch according to claim 31, wherein the watch case body of the watch case is formed by at least one material selected from gold, silver, copper, brass, aluminum, magnesium, zinc and their alloy.

44. The radio controlled watch according to claim 31, wherein the watch case body of the watch case is formed by bonding at least two materials selected from gold, silver, copper, brass, aluminum, magnesium, zinc and their alloy.

45. The radio controlled watch according to claim 31, wherein the watch case body of the watch case is formed of a hard metal.

46. The radio controlled watch according to claim 31, wherein the back cover of the watch case is formed by at least one material selected from titanium, a titanium alloy, stainless steel, tungsten carbide and tantalum carbide.

47. The radio controlled watch according to claim 31, wherein the back cover of the watch case is formed by at least one material selected from gold, silver, copper, brass, aluminum, magnesium, zinc and their alloy.

48. The radio controlled watch according to claim 31, wherein the back cover of the watch case is formed by bonding at least two materials selected from gold, silver, copper, brass, aluminum, magnesium and their alloy.

49. The radio controlled watch according to claim 31, wherein the back cover of the watch case is formed of a hard metal.

50. The radio controlled watch according to claim 31, wherein at least one of the watch case body and the back cover of the watch case is subjected to a surface treatment and/or a hardening treatment.

51. The radio controlled watch according to claim 31, wherein an internal surface of the watch case body of the watch case and an external side surface of the antenna are provided in substantially parallel with each other as seen on a plane.

52. The radio controlled watch according to claim 31, wherein an internal surface of the back cover of the watch case and an external side surface of the antenna are provided in substantially parallel with each other.

53. The radio controlled watch according to claim 31, wherein one end face of both ends in an axial direction of the antenna is provided in substantially parallel with an internal surface of the back cover of the watch case.

54. The radio controlled watch according to claim 31, wherein one end face of both ends in an axial direction of the antenna is provided substantially perpendicularly to an internal surface of the back cover of the watch case.

55. The radio controlled watch according to claim 31, wherein an external side surface of the antenna is provided substantially perpendicularly to an internal surface of the back cover of the watch case.

56. The radio controlled watch according to claim 31, wherein the back cover of the watch case takes a two-dimensional planar shape.

57. The radio controlled watch according to claim 31, wherein at least one non-magnetic member having an electric resistivity of 7.0 μΩ-Cm or less is fixed to the internal surface of the watch case.

58. The radio controlled watch according to claim 57, wherein the non-magnetic member is constituted by at least one material selected from gold, silver, copper, brass, aluminum, magnesium, zinc and their alloy.

59. The radio controlled watch according to claim 57, wherein the non-magnetic member is formed by bonding at least two materials selected from gold, silver, copper, brass, aluminum, magnesium and their alloy.

60. The radio controlled watch according to claim 57, wherein the antenna is constituted by a magnetic core member and a coil wound around the magnetic core member in plural turns, and
a member of the watch case onto which the antenna is projected in parallel along at least one plane including an axis of the magnetic core member or a portion onto which the projected member of the watch case is projected is constituted by the non-magnetic member.

61. The radio controlled watch according to claim 57, wherein the antenna is constituted by a magnetic core member and a coil wound around the magnetic core member in plural turns, and
a member of the watch case opposed to at least one end in an axial direction of the antenna or a portion opposed to the member of the watch case opposed to the end in the axial direction is constituted by the non-magnetic member.

62. A radio controlled watch comprising:
an antenna for receiving a radio wave including time information;
a watch device for causing a display portion to display time information such as a present time by the radio wave received by the antenna;
an antimagnetic plate for preventing an influence of an external magnetism; and
a watch case for accommodating the antenna, the watch device and the antimagnetic plate,
wherein the antimagnetic plate provided in the watch case has an opening portion in an opposed part to the antenna.

63. The radio controlled watch according to claim 62, wherein the antenna is constituted by a magnetic core member and a coil wound around the magnetic core member in plural turns, and
an opening portion is provided on the antimagnetic plate in a position in which the antenna is projected in parallel along at least one plane including an axis of the magnetic core member.

64. The radio controlled watch according to claim 62, wherein the antenna is constituted by a magnetic core member and a coil wound around the magnetic core member in plural turns, and
an opening portion is provided on the antimagnetic plate in an opposed position to at least one end in an axial direction of the antenna.

65. The radio controlled watch according to claim 62, wherein the antenna is provided to be positioned on an outside of the antimagnetic plate.

66. The radio controlled watch according to claim 62, wherein the antenna has at least a part protruded from the opening portion of the antimagnetic plate and positioned on an internal surface side of a case body of the watch case.

67. The radio controlled watch according to claim 62, wherein the antenna has at least a part protruded from the opening portion of the antimagnetic plate and positioned on a back cover side of the watch case.

68. The radio controlled watch according to claim 62, wherein the antenna has at least a part protruded from the opening portion of the antimagnetic plate and positioned on a display plate side.

69. The radio controlled watch according to claim 62, wherein the antimagnetic plate is formed by at least one material selected from pure iron and Permalloy.

70. The radio controlled watch according to claim 62, wherein a non-magnetic member having an electric resistivity of 7.0 μΩ-Cm or less is provided on an internal surface of the antimagnetic plate.

71. The radio controlled watch according to claim 62, wherein the non-magnetic member is provided in the opening portion of the antimagnetic plate.

72. The radio controlled watch according to claim 70, wherein the non-magnetic member is constituted by at least one material selected from gold, silver, copper, brass, aluminum, magnesium, zinc and their alloy.

73. The radio controlled watch according to claim 70, wherein the non-magnetic member is formed by bonding at least two materials selected from gold, silver, copper, brass, aluminum, magnesium, zinc and their alloy.

74. The radio controlled watch according to claim 62, wherein the non-magnetic member has a rising portion erected in a direction of the display plate, and
the rising portion abuts on a part of the watch case, thereby regulating a rotation of the antimagnetic plate.

75. A radio controlled watch comprising:
an antenna for receiving a radio wave including time information;
a watch device for causing a display portion to display time information such as a present time by the radio wave received by the antenna; and
a watch case for accommodating the antenna and the watch device,
wherein the watch case is constituted by an electrically non-conductive material or a material having a low electric resistivity, and
an exterior member formed by an electrically conductive material which is attached to an outside of the watch case is provided.

76. The radio controlled watch according to claim 75, wherein the exterior member covers an upper surface of a watch case body of the watch case.

77. The radio controlled watch according to claim 75, wherein the exterior member covers an external side surface of the watch case body of the watch case.

78. The radio controlled watch according to claim 75, wherein the electrically non-conductive material constituting the watch case is formed by at least one electrically non-conductive material selected from a synthetic resin, rubber and ceramic.

79. The radio controlled watch according to claim 75, wherein a material having a low electric resistivity which constitutes the watch case includes at least one material having a low electric resistivity which is selected from gold, silver, copper, brass, aluminum, magnesium and their alloy.

80. The radio controlled watch according to claim 75, wherein an electrically conductive material constituting the exterior member includes at least one electrically conductive material selected from stainless, titanium and a titanium alloy.
